(19) United States
(12) Patent Application Publication
(10) Pub. No.: US 2018/0160118 A1
(43) Pub. Date: Jun. 7, 2018

(54) ARITHMETIC DECODING DEVICE AND ARITHMETIC CODING DEVICE

(71) Applicant: Sharp Kabushiki Kaisha, Sakai City, Osaka (JP)

(72) Inventors: Takeshi TSUKUBA, Sakai City (JP); Tomohiro IKAI, Sakai City (JP)

(21) Appl. No.: 15/735,982

(22) PCT Filed: May 13, 2016
(86) PCT No.: PCT/JP2016/064339

§ 371 Date: Dec. 13, 2017

(30) Foreign Application Priority Data
Jun. 18, 2015 (JP) 2015-122742

(51) Int. Cl. H04N 19/13; H04N 19/136; H04N 19/176; H04N 19/196; H04N 19/70

(52) U.S. Cl. CPC H04N 19/13; H04N 19/136; H04N 19/70; H04N 19/196; H04N 19/176

(57) ABSTRACT

The decoding processing amount is reduced. An increase of the number of contexts relating to a CU split identifier is suppressed while coding efficiency is maintained. In addition, context index derivation processing regarding a CU split identifier is simplified. An arithmetic decoding device includes context index deriving means for deriving a context index for designating a context, arithmetic code decoding means for decoding a Bin sequence configured by one or a plurality of Bins, from coded data with reference to a bypass flag and the context designated by the context index, and CU split identifier decoding means for decoding a syntax value of a CU split identifier relating to a target CU, from the Bin sequence. The context index deriving means derives the context index relating to the CU split identifier, based on a split depth of the target CU and split depths of one or more decoded neighboring CUs.

### TECHNICAL FIELD

The present invention relates to an arithmetic decoding device configured to decode coded data which is arithmetically coded, and an image decoding apparatus including an arithmetic coding device. In addition, the present invention relates to an arithmetic coding device configured to generate coded data which is arithmetically coded, and an image coding apparatus including the arithmetic coding device.

### BACKGROUND ART

A video coding apparatus and a video decoding apparatus are used for efficiently transmitting or recording a video. The video coding apparatus codes a video so as to generate coded data, and the video decoding apparatus decodes the coded data so as to generate decoded image.

Specific examples of a video coding method include methods (NPL 1) proposed in H.264/MPEG-4.AVC, and high-efficiency video coding (HEVC) which is a succeeding codec thereof.

In such video coding methods, an image (picture) constituting a video is managed in a hierarchical structure and is generally coded and decoded for each block. The hierarchical structure is configured by a slice, a coding unit (may also be referred to as a CU), a prediction unit (PU), and a transform unit (TU). The slice is obtained by dividing the image and the coding unit is obtained by dividing the slice. The prediction unit and the transform unit are blocks obtained by dividing the coding unit.

In such video coding methods, generally, a predicted image is generated based on a local decoded image which is obtained by coding and decoding an input image, and a prediction residual (may also be referred to as “a difference image” or “a residual image”) obtained by subtracting the predicted image from the input image (original image) is coded. Examples of a method of generating a predicted image include inter-frame prediction (inter-prediction) and intra-frame prediction (intra-prediction).

In NPL 1, a technology in which a coding unit and a transform unit having a block size of the high degree of freedom are selected by quadtree partition, so as to obtain balance between the code amount and accuracy is known. Split into a coding unit having a block size of 64×64, 32×32, 16×16, and up to 8×8 can be performed in a manner that quadtree partition is recursively repeated on the maximum coding unit having a 64×64 block size until the minimum coding unit is obtained, based on a value of a flag (CU split flag) which indicates whether or not quadtree partition is performed on a coding unit having the block size.

NPL 2 discloses quadtree partition of a coding unit in a case where the size of the maximum coding unit is expanded from a size of 64×64 to a block size of 512×512 in maximum. Similar to NPL 1, split into a coding unit having a block size of 512×512, 256×256, 128×128, 64×64, 32×32, 16×16, and up to 8×8 can be performed in a manner that quadtree partition is recursively repeated on the maximum coding unit having a 512×512 block size until the minimum coding unit is obtained, based on a coding-unit CU split flag having the block size.

### CITATION LIST

### Non Patent Literature

NPL 1: ITU-T Rec. H.265 (V2) (published on Oct. 29, 2014)

NPL 2: J. Chen et al., “Coding tools investigation for next generation video coding”, ITU-T STUDY GROUP 16 COM16-C806-E (published in January, 2015)

### SUMMARY OF INVENTION

### Technical Problem

However, in NPL 2, there are problems in that, when a coding unit is expanded to the maximum size, context index derivation processing of designating a context relating to a CU split flag indicating whether or not quadtree partition is performed on the coding unit is complicated and the number of contexts is increased. More specifically, in NPL 2, a context index different from “a context index derived based on the split depth of a target CU and the split depth of the surrounding decoded (coded) CU which is adjacent to the target CU” is repetitively derived in a case where the split depth of the target CU is equal to or smaller than the minimum value of the split depth of the neighboring CU and is equal to or greater than the maximum value of the split depth of the neighboring CU, when a context index relating to a CU split flag is derived with reference to the split depth of the target CU and the split depth of the neighboring decoded (coded) CU which is adjacent to the target CU. Thus, there are problems in that the context index derivation processing is complicated and a memory size for holding a context is increased with an increase of the number of contexts.

### Solution to Problem

To solve the above problems, according to a first aspect of the present invention, there is provided an arithmetic decoding device which includes context index deriving means for designating a context, arithmetic code decoding means for decoding a Bin sequence configured by one or a plurality of Bins, from coded data with reference to a bypass flag and the context designated by the context index, and CU split identifier decoding means for decoding a syntax value of a CU split identifier relating to a target CU, from the Bin sequence. The context index deriving means derives the context index relating to the CU split identifier, based on a split depth of the target CU and split depths of one or more decoded neighboring CUs.

To solve the above problems, according to a second aspect of the present invention, there is provided an arithmetic coding device which includes CU split identifier coding means for coding a syntax value of a CU split identifier relating to a target CU, in a form of a Bin sequence, context index deriving means for designating a context, and arithmetic code coding means for generating coded data with reference to a bypass flag and the context designated by the context index, by coding a Bin sequence configured by one or a plurality of Bins. The context index deriving means derives the context index relating to the CU split identifier, based on a split depth of the target CU and split depths of one or more coded neighboring CUs.

### Advantageous Effects of Invention

According to the aspect of the present invention, since the context index deriving means derives a context index relating to a CU split identifier, based on the split depth of a target CU and split depths of one or more decoded neighboring CUs, an increase of the number of contexts relating to a CU split identifier is suppressed while coding efficiency is maintained, and context index derivation processing regarding a CU split identifier is simplified. Accordingly, an effect of reducing the decoding processing amount is exhibited.

According to the other aspect of the present invention, since the context index deriving means derives a context index relating to a CU split identifier, based on the split depth of a target CU and split depths of one or more coded neighboring CUs, an increase of the number of contexts relating to a CU split identifier is suppressed while coding efficiency is maintained, and context index derivation processing regarding a CU split identifier is simplified. Accordingly, an effect of reducing the coding processing amount is exhibited.

### BRIEF DESCRIPTION OF DRAWINGS

FIG. 1 is a functional block diagram illustrating a configuration example of an arithmetic decoding unit provided in a decoding module according to an embodiment of the present invention.

FIG. 2 is a functional block diagram schematically illustrating a configuration of a video decoding apparatus according to the embodiment of the present invention.

FIG. 3 is a diagram illustrating data configuration of coded data which is generated by the video coding apparatus according to the embodiment of the present invention and is decoded by the video decoding apparatus, in which FIGS. 3(a) to 3(d) are diagrams respectively illustrating a picture layer, a slice layer, a tree block layer, and a CU layer.

FIG. 4 is a flowchart schematically illustrating an operation of the video decoding apparatus.

FIG. 5 is a diagram illustrating a PU split type pattern, in which FIGS. 5(a) to 5(h) respectively illustrate partition shapes in cases where the PU split type is 2N×2N, 2N×N, 2N×nU, 2N×nD, N×2N, nL×2N, nR×2N, and N×N.

FIG. 6 is a flowchart schematically illustrating an operation of a CU information decoding unit 11 (CTU information decoding S1300 and CT information decoding S1400) according to the embodiment of the present invention.

FIG. 7 is a flowchart illustrating context index derivation processing regarding a CU split identifier, according to the embodiment of the present invention.

FIG. 8 illustrates an example of a pseudo-code indicating the context index derivation processing regarding a CU split identifier, according to the embodiment of the present invention.

FIG. 9 illustrates an example of a pseudo-code indicating derivation processing of an available flag AvaialableNFlag of a block in a Z scan order, according to the embodiment of the present invention.

FIG. 10 is a diagram illustrating an example of a context value (context increment value) corresponding to a Bin position of each syntax of a CU split identifier, according to the embodiment of the present invention.

FIG. 11 is a diagram illustrating an example of correspondence between a syntax value and a Bin sequence of a CU split identifier and correspondence of an offset (dxA, dyA), in which FIG. 11(a) illustrates the example of the correspondence between the syntax value and the Bin sequence of the CU split identifier, and FIG. 11(b) is a diagram illustrating the correspondence of the offset (dxA, dyA).

FIG. 12 is a diagram illustrating correspondence of the offset (dxA, dyA) to positions of a target CU and the neighboring CU, and is a diagram illustrating the target CU and the neighboring CUA (A=L, LB, T, TR), in which FIG. 12(a) illustrates an example of the offset (dxA, dyA) and FIG. 12(b) is a diagram illustrating an example of a positional relationship between the target CU and the neighboring CUA (A=L, LB, T, TR).

FIG. 13 is a flowchart illustrating a first modification of the context index derivation processing regarding a CU split identifier, according to the embodiment of the present invention.

FIG. 14 is a flowchart schematically illustrating an operation of the CU information decoding unit (CU information decoding S1500), a PU information decoding unit 12 (PU information decoding S1600), and a TU information decoding unit 13 (TU information decoding S1700), according to the embodiment of the present invention.

FIG. 15 is a flowchart schematically illustrating an operation of the TU information decoding unit 13 (TT information decoding S1700), according to the embodiment of the present invention.

FIG. 16 is a flowchart schematically illustrating an operation of the TU information decoding unit 13 (TU information decoding S1760), according to the embodiment of the present invention.

FIG. 17 is a diagram illustrating a configuration example of a syntax table of CU information according to the embodiment of the present invention.

FIG. 18 is a diagram illustrating a configuration example of a syntax table of CU information, PT information PTI, and TT information TTI according to the embodiment of the present invention.

FIG. 19 is a diagram illustrating a configuration example of a syntax table of PT information PTI according to the embodiment of the present invention.

FIG. 20 is a diagram illustrating a configuration example of a syntax table of TT information TTI according to the embodiment of the present invention.

FIG. 21 is a diagram illustrating a configuration example of a syntax table of TU information according to the embodiment of the present invention.

FIG. 22 is a diagram illustrating a configuration example of a syntax table of a quantized prediction residual according to the embodiment of the present invention.

FIG. 23 is a diagram illustrating a configuration example of a syntax table of quantized prediction residual information according to the embodiment of the present invention.

FIG. 24 is a functional block diagram schematically illustrating a configuration of a video coding apparatus according to the embodiment of the present invention.

FIG. 25 is a functional block diagram illustrating a configuration example of an arithmetic coding unit provided in a coded data generation unit according to the embodiment of the present invention.

FIG. 26 illustrates configurations of transmission equipment equipped with the video coding apparatus and reception equipment equipped with the video decoding apparatus, in which FIG. 26(a) illustrates the transmission equipment equipped with the video coding apparatus, and FIG. 26(b) illustrates the reception equipment equipped with the video decoding apparatus.

FIG. 27 illustrates configurations of recording equipment equipped with the video coding apparatus and reproducing equipment equipped with the video decoding apparatus, in which FIG. 27(a) illustrates the recording equipment equipped with the video coding apparatus, and FIG. 27(b) illustrates the reproducing equipment equipped with the video decoding apparatus.

FIG. 28 is a flowchart illustrating context index derivation processing regarding a CU split flag in NPL 1.

FIG. 29 is a flowchart illustrating context index derivation processing regarding a CU split flag in NPL 2.

### DESCRIPTION OF EMBODIMENTS

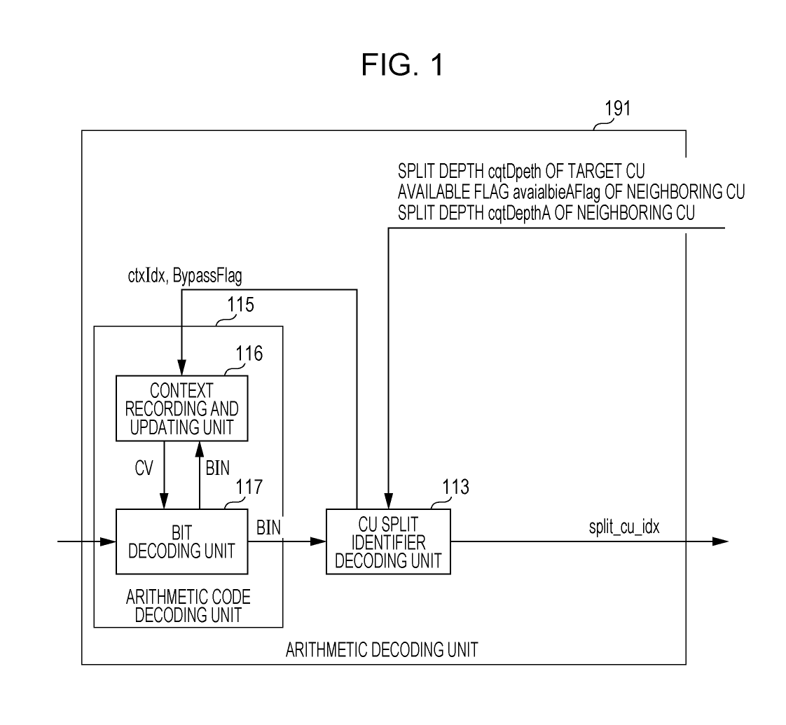

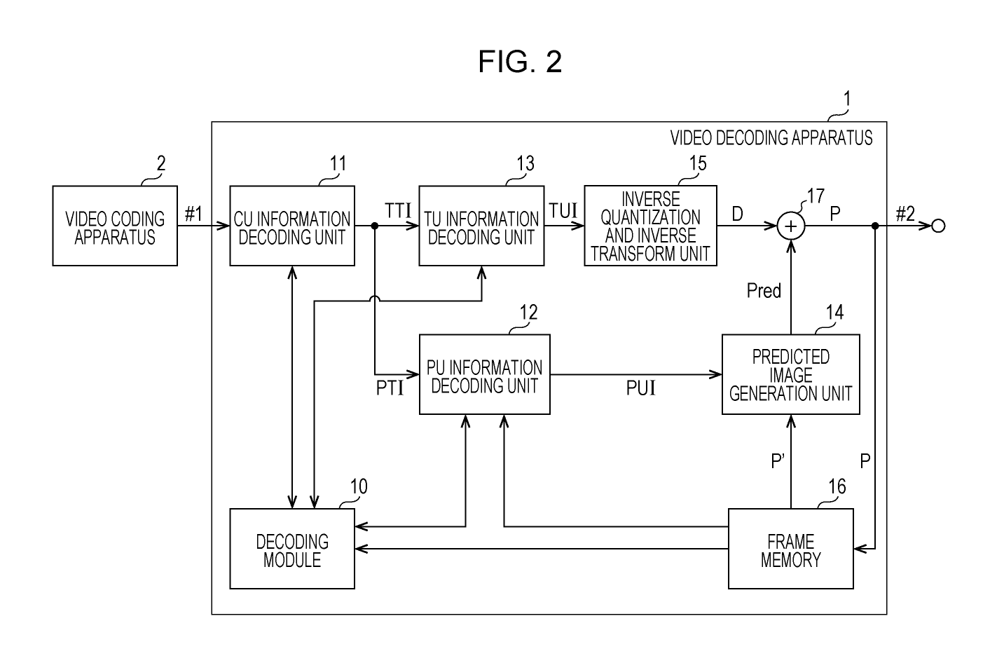

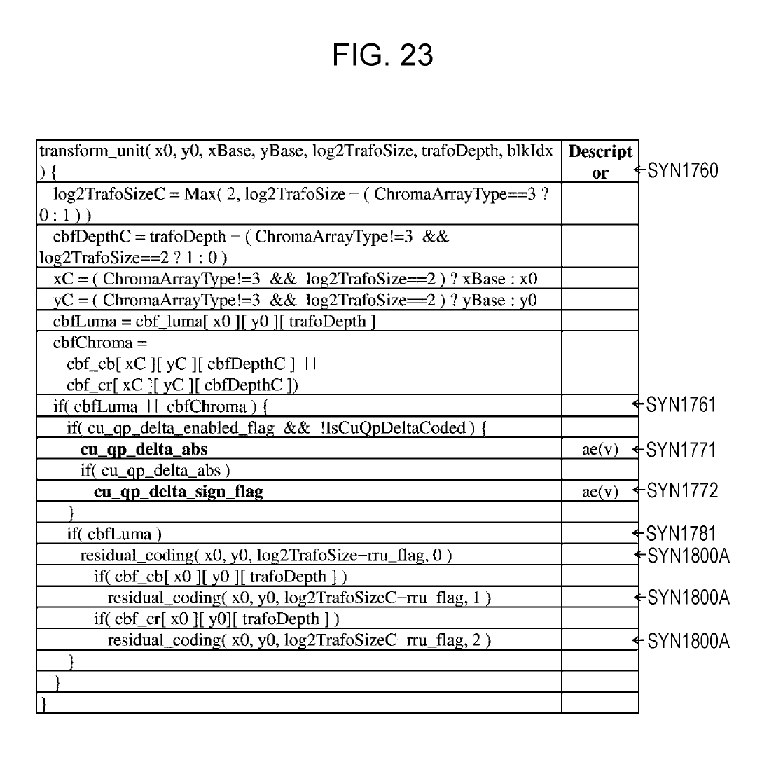

An embodiment of the present invention will be described with reference to FIGS. 1 to 29. Firstly, an outline of a video decoding apparatus (image decoding apparatus) 1 and a video coding apparatus (image coding apparatus) 2 will be described with reference to FIG. 2. FIG. 2 is a functional block diagram schematically illustrating a configuration of the video decoding apparatus 1.

The video decoding apparatus 1 and the video coding apparatus 2 illustrated in FIG. 2 use a technique employed in high efficiency video coding (HEVC). The video coding apparatus 2 performs entropy coding of a value of a syntax in which transmission from an encoder to a decoder is prescribed, so as to generate coded data #1 in this video coding method.

As the entropy coding method, context-based adaptive variable length coding (CAVLC) and context-based adaptive binary arithmetic coding (CABAC) are known.

In coding and decoding performed by CAVLC and CABAC, processing which is adaptive based on a context is performed. The context refers to a situation (context) of coding or decoding, and is defined based on the previous coding or decoding result of an associated syntax. As the associated syntax, for example, various types of syntax regarding intra-prediction and inter-prediction, various types of syntax regarding luminance (Luma), chrominance (Chroma), and various types of syntax regarding a coding unit (CU) size are provided. In the CABAC, the position of binary as a target of coding or decoding may be used as a context in binary data (binary sequence) corresponding to a syntax.

In the CAVLC, various types of syntax are coded by adaptively changing a VLC table which is used in coding. In the CABAC, binarization processing is performed on a syntax for allowing values regarding a prediction mode, a transform coefficient, and the like to be obtained. Binary data obtained by the binarization processing is adaptively subjected to arithmetic coding in accordance with an occurrence probability. Specifically, a plurality of buffers for holding an occurrence probability of a binary value (0 or 1) are prepared. One buffer is selected in accordance with a context, and arithmetic coding is performed based on the occurrence probability recorded in the selected buffer. It is possible to maintain an occurrence probability suitable for a context by updating the occurrence probability of the buffer based on the coded or decoded binary value.

Coded data #1 obtained by the video coding apparatus 2 coding a video is input to the video decoding apparatus 1. The video decoding apparatus 1 decodes the input coded data #1 and outputs a video #2 to the outside of the apparatus 1. Ahead of detailed descriptions of the video decoding apparatus 1, a configuration of the coded data #1 will be described below.

[Configuration of Coded Data]

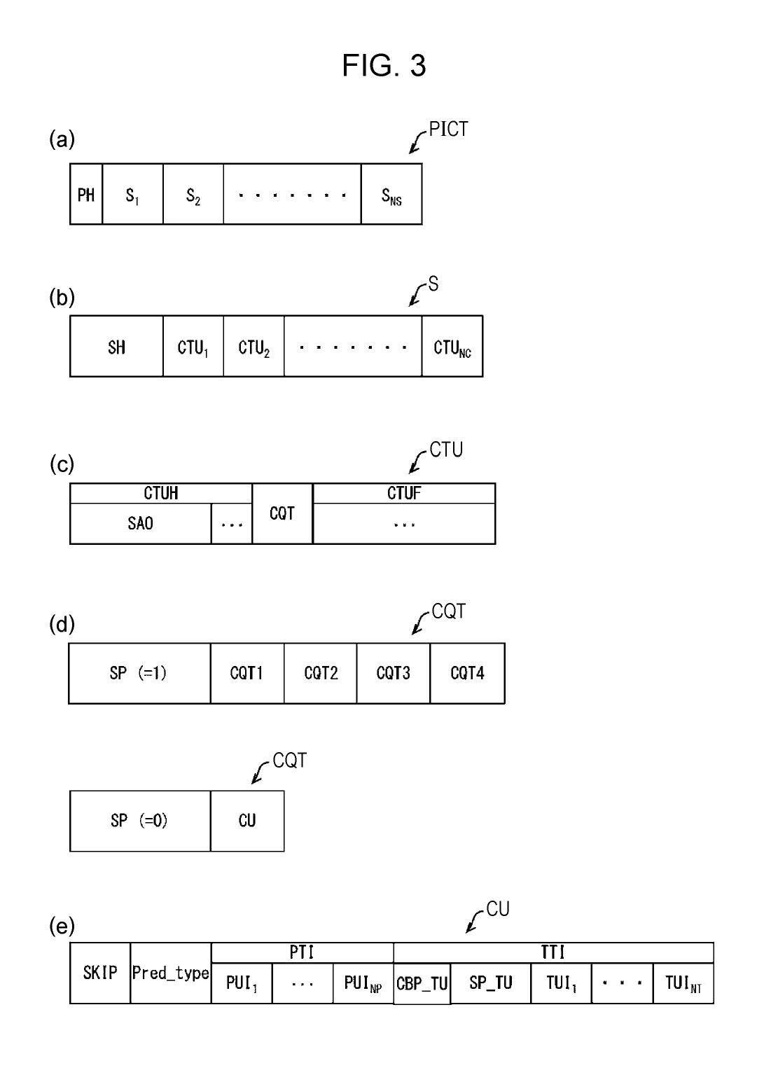

A configuration example of coded data #1 which is generated by the video coding apparatus 2 and is decoded by the video decoding apparatus 1 will be described with reference to FIG. 3. The coded data #1 includes a sequence and a plurality of pictures constituting the sequence, as an example.

FIG. 3 illustrates a hierarchical structure of layers which are equal to or lower than a picture layer in the coded data #1. FIG. 3(a) is a diagram illustrating a picture layer which prescribes a picture PICT. FIG. 3(b) is a diagram illustrating a slice layer which prescribes a slice S. FIG. 3(c) is a diagram illustrating a tree block layer which prescribes a coding tree block CTB. FIG. 3(d) is a diagram illustrating a coding tree layer which prescribes a coding tree (CT). FIG. 3(e) is a diagram illustrating a CU layer which prescribes a coding unit (CU) included in the coding tree block CTU.

(Picture Layer)

In a picture layer, sets of data which are referred to by the video decoding apparatus 1 in order to decode a picture PICT (also referred to as a target picture below) as a processing target are prescribed. The picture PICT includes a picture header PH and slices S1 to SNS (where NS indicates a total number of slices included in the picture PICT), as illustrated in FIG. 3(a).

In addition, in the following descriptions, in a case where the respective slices S₁ to S_{NS} are not required to be differentiated from each other, the subscripts may be omitted. Further, this is also the same for other data which is included in the coded data #1 described below and is given a subscript.

The picture header PH includes a coding parameter group which is referred to by the video decoding apparatus 1 in order to determine a decoding method of a target picture. The picture header PH is also referred to as a picture parameter set (PPS).

(Slice Layer)

In a slice layer, sets of data which are referred to by the video decoding apparatus 1 in order to decode a slice S (also referred to as a target slice below) as a processing target are prescribed. The slice S includes a slice header SH and tree blocks CTU₁ to CTU_{Nc} (where NC indicates a total number of tree blocks included in the slice S), as illustrated in FIG. 3(b).

The slice header SH includes a coding parameter group which is referred to by the video decoding apparatus 1 in order to determine a decoding method of a target slice. Slice type designation information (slice_type) for designating a slice type is an example of a coding parameter included in the slice header SH.

Examples of slice types which can be designated by the slice type designation information include (1) an I slice which uses only intra-prediction during coding, (2) a P slice which uses uni-prediction or intra-prediction during coding, and (3) a B slice which uses uni-prediction, bi-prediction, or intra-prediction during coding.

The slice header SH may include a filter parameter which is referred to by a loop filter (not illustrated) which is provided in the video decoding apparatus 1.

(Tree Block Layer)

In a tree block layer, sets of data which are referred to by the video decoding apparatus 1 in order to decode a tree block CTU (also referred to as a target tree block below) as a processing target are prescribed. The tree block CTB is a block obtained by splitting a slice (picture) into blocks having a fixed size. Regarding the tree block which is a block having a fixed size, the tree block may be referred to as a tree block in a case of focusing on image data (pixel) of a region, and the tree block may be referred to as a tree unit in a case of also including information (for example, split information and the like) for decoding image data in addition to the image data of a region. In the following descriptions, the above tree block is simply referred to as a tree block CTU without distinguishment. In the following descriptions, a case of also including information (for example, split information and the like) for decoding image data in addition to a coding tree, a coding unit, and image data of the corresponding region.

The tree block CTU includes a tree block header CTUH and coding unit information CQT. Here, firstly, a relationship between the tree block CTU and the coding tree CT will be described as follows.

The tree block CTU is a unit obtained by splitting a slice (picture) into units having a fixed size.

The tree block CTU has a coding tree (CT). The coding tree (CT) is split by recursive quadtree partition. A tree structure and nodes thereof obtained by the recursive quadtree partition are referred to as a coding tree below.

A unit corresponding to a leaf which is a terminal node of the coding tree is referred to as a coding node below. In addition, the coding node is a basic unit in coding processing. Thus, the coding node is referred to as a coding unit (CU) below. That is, the coding tree CT on the top is a CTU (CQT) and the coding tree CT at the terminal is a CU.

That is, pieces of coding unit information CU1 to CUNL are pieces of information which respectively correspond to coding nodes (coding units) which are obtained by performing recursive quadtree partition on a tree block CTU.

A root of the coding tree is correlated with the tree block CTU. In other words, the tree block CTU (CQT) is correlated with the top node of a tree structure which is obtained by quadtree partition and recursively includes a plurality of coding nodes (CT).

The size of each coding node is a half of a size of a coding node (that is, a unit of a node which is higher than this coding node by one level) vertically and horizontally, to which the corresponding coding node directly belongs.

Further, a size which may be taken by each coding node depends on size designation information and a maximum hierarchical depth (or also referred to as a maximum split depth) of a coding node. The size designation information and the maximum hierarchical depth are included in a sequence parameter set SPS of the coded data #1. For example, in a case where the size of a tree block CTU corresponds to 128×128 pixels and the maximum hierarchical depth MaxCqtDepth is 4, a coding node in a layer which is equal to or lower than the tree block CTU may have any size of five types of sizes, that is, 128×128 pixels at a hierarchical depth (also referred to as a split depth) CqtDepth=0, 64×64 pixels at a hierarchical depth CqtDepth=1, 32×32 pixels at a hierarchical depth CqtDepth=2, 16×16 pixels at a hierarchical depth CqtDepth=3, and 8×8 pixels at a hierarchical depth CqtDepth=4.

(Tree Block Header)

A tree block header CTUH includes coding parameters which are referred to by the video decoding apparatus 1 in order to determine a decoding method of a target tree block. Specifically, as illustrated in FIG. 3(c), the tree block header CTUH includes SAO for designating a filtering method of a target tree block. Information such as a CTUH, which is included in a CTU, is referred to as coding tree unit information (CTU information).

(Coding Tree)

A coding tree CT has tree block split information SP which is information for splitting a tree block. For example, specifically, as illustrated in FIG. 3(d), the tree block split information SP may be a CU split identifier (split_cu_idx) which is an identifier indicating whether or not the entirety of a target tree block or a partial area of a tree block is split into four parts. In a case where the CU split identifier split_cu_idx is 1, a coding tree CT is further split into 4 coding trees CT. In a case where split_cu_idx is 0, this means that the corresponding coding tree CT is a terminal node which is no more split. Information such as the CU split flag split_cu_idx, which is provided for the coding tree is referred to as coding tree information (CT information). The CT information may include parameters applied to the coding tree and a coding unit which is equal to or lower than the coding tree, in addition to the CU split flag split_cu_idx indicating whether or not this coding tree is more split. The CU split identifier split_cu_idx is not limited to the binary for indicating whether or not the quadtree partition is performed. For example, a coding tree CT is subjected to binary tree partition in a horizontal direction (N×2N which will be described later) when split_cu_idx=2. When split_cu_idx=3, a coding tree CT is subjected to the binary tree partition in a vertical direction (2N×N which will be described later). A CU splitting method may be assigned in the above-described manner. Correlation between the CU split identifier split_cu_idx and a splitting method may be changed in a practicable range.

(CU Layer)

In the CU layer, sets of data which are referred to by the video decoding apparatus 1 in order to decode a CU (also referred to as a target CU below) as processing target are prescribed.

Here, ahead of detailed descriptions of content of data included in coding unit information CU, a tree structure of data included in the CU will be described. A coding node is a node at the roots of a prediction tree (PT) and a transform tree (TT). The prediction tree and the transform tree will be described.

In the prediction tree, a coding node is split into one or a plurality of prediction blocks, and a position and a size of each prediction block are prescribed. In other words, the prediction block corresponds to one or a plurality of regions which do not overlap each other. The one or the plurality of regions constitute the coding node. In addition, the prediction tree includes one or a plurality of prediction blocks obtained by the above-described splitting.

Prediction processing is performed for each of the prediction blocks. The prediction block which is the unit of prediction is also referred to as a prediction unit (PU) below.

Types of splits in the prediction tree roughly include two types of intra-prediction and inter-prediction.

In a case of intra-prediction, as a splitting method, there are 2N×2N (which is the same size as that of a coding node) and N×N.

In addition, in a case of inter-prediction, as a splitting method, there are 2N×2N (which is the same size as that of a coding node), 2N×N, N×2N, N×N, and the like.

Further, in the transform tree, a coding node is split into one or a plurality of transform blocks, and a position and a size of each transform block are prescribed. In other words, the transform block corresponds to one or a plurality of regions which do not overlap each other. The one or the plurality of regions constitute the coding node. The transform tree includes one or a plurality of transform blocks obtained by the above-described splitting.

Transform processing is performed for each of the transform blocks. The transform block which is the unit of transform is also referred to as a transform unit (TU) below.

(Data Structure of Coding Unit Information)

Next, content of data included in coding unit information CU will be specifically described with reference to FIG. 3(e). As illustrated in FIG. 3(e), the coding unit information CU includes, specifically, CU information (skip flag SKIP and CU prediction type information Pred_type), PT information PTI, and TT information TTI.

[Skip Flag]

The skip flag SKIP is a flag (skip flag) indicating whether or not a skip mode is applied to a target CU. In a case where a value of the skip flag SKIP is 1, that is, the skip mode is applied to a target CU, the PT information PTI and the TT information TTI in the coding unit information CU are omitted. The skip flag SKIP is omitted in an I slice.

[CU Prediction Type Information]

CU prediction type information Pred_type includes CU prediction method information (PredMode) and PU split type information (PartMode).

The CU prediction method information (PredMode) is used for designating one of the skip mode, intra-prediction (intra-CU), and inter-prediction (inter-CU) as a predicted image generation method for each PU included in a target CU. The type of skip, intra-prediction, and inter-prediction is referred to as a CU prediction mode in a target CU, below.

The PU split type information (PartMode) is used for designating a PU split type which is a pattern of split of a target coding unit (CU) into PUs. Hereinafter, as mentioned above, splitting target coding unit (CU) into PUs according to a PU split type is referred to as PU split.

For example, the PU split type information (PartMode) may be an index indicating the type of PU split pattern, and may designate a shape, a size, and a position in a target prediction tree, of each PU included in the target prediction tree. PU split is also referred to as a prediction unit split type.

A selectable PU split type varies depending on a CU prediction type and a CU size. Further, the selectable PU split type is different in each case of inter-prediction and intra-prediction. Details of the PU split type will be described later.

In a case of not being an I slice, the value of the CU prediction method information (PredMode) and the value of the PU split type information (PartMode) may be specified in accordance with an index (cu_split_pred_part_mode) for designating a combination of the CU split identifier (split_cu_idx), the skip flag (skip_flag), a merge flag (merge_flag; described later), the CU prediction method information (PredMode), and the PU split type information (PartMode). The index such as cu_split_pred_part_mode is also referred to as joined syntax (or joint code).

[PT information]

PT information PTI is information regarding a PT included in a target CU. In other words, the PT information PTI is a set of pieces of information regarding one or a plurality of PUs included in a PT. As described above, a predicted image is generated by using a PU as a unit. Thus, the PT information PTI is referred to when the predicted image is generated by the video decoding apparatus 1. The PT information PTI includes pieces of PU information PUI1 to PUINP (where NP indicates a total number of PUs included in a target PT) including prediction information in each PU as illustrated in FIG. 3(d).

The prediction information PUI includes intra-prediction information or inter-prediction information in accordance with a prediction type designated by the prediction type information Pred_mode. A PU to which intra-prediction is applied is referred to as an intra-PU below, and a PU to which inter-prediction is applied is referred to as an inter-PU below.

The inter-prediction information includes coding parameters which are referred to when the video decoding apparatus 1 generates an inter-predicted image by inter-prediction.

Examples of the inter-prediction parameter include a merge flag (merge_flag), a merge index (merge_idx), an estimated motion vector index (mvp_idx), a reference image index (ref_idx), an inter-prediction flag (inter_pred_flag), and a motion vector difference (mvd).

The intra-prediction information includes coding parameters which are referred to when the video decoding apparatus 1 generates an intra-predicted image by intra-prediction.

Examples of the intra-prediction parameter include an estimated prediction mode flag, an estimated prediction mode index, and a remaining prediction mode index.

In addition, in the intra-prediction information, a PCM mode flag indicating whether or not a PCM mode is used may be coded. In a case where the PCM mode flag is coded, and when the PMC mode flag indicates that a PCM mode is used, each of (intra) prediction processing, transform processing, and entropy coding processing is omitted.

[TT information]

TT information TTI is information regarding a TT included in a CU. In other words, the TT information TTI is a set of pieces of information regarding one or a plurality of TUs included in a TT, and the TT information TTI is referred to when the video decoding apparatus 1 decodes residual data. A TU may be referred to as a block below.

As illustrated in FIG. 3(e), the TT information TTI includes a CU residual flag CBP_TU which is information indicating whether or not a target CU includes residual data, TT split information SP_TU for designating a split pattern of a target CU into transform blocks, and pieces of TU information TUI₁ to TUI_{NT} (where NT indicates a total number of blocks included in a target CU).

In a case where the CU residual flag CBP_TU is 0, the target CU does not include residual data, that is, TT information TTI. In a case where the CU residual flag CBP_TU is 1, the target CU includes residual data, that is, TT information TTI. The CU residual flag CBP_TU may be, for example, a residual root flag rqt_root_cbf (Residual Quad Tree Root Coded Block Flag) indicating that residual is not provided in any of all residual blocks obtained by splitting a unit which is equal to or lower than a target block. Specifically, the TT split information SP TU is information for determining a shape, a size, and a position in a target CU, of each TU included in the target CU. For example, the TT split information SP_TU may be realized by a TU split flag (split_transform_flag) indicating whether or not a target node will be split, and a TU depth (TU level, trafoDepth) indicating a depth of the split. The TU split flag split_transform_flag is a flag indicating whether or not a transform block for performing transform (inverse transform) is split. In a case of being split, transform (inverse transform, inverse quantization, and quantization) is performed by using a smaller block.

For example, in a case where the size of a CU is 64×64, each TU which is obtained by splitting may take sizes of 32×32 pixels to 4×4 pixels.

The pieces of TU information TUI₁ to TUI_{NT} are pieces of information regarding one or a plurality of TUs included in a TT. For example, the TU information TUI includes a quantized prediction residual.

Each quantized prediction residual is coded data generated in a manner that the video coding apparatus 2 performs the following Processing 1 to 3 on a target block which is a block as a processing target.

Processing 1: perform discrete cosine transform (DCT) on a prediction residual which is obtained by subtracting a predicted image from a coding target image;

Processing 2: quantize a transform coefficient obtained in Processing 1;

Processing 3: perform variable length coding on the transform coefficient quantized in Processing 2;

The above-described quantization parameter qp indicates the size of a quantization step QP used when the video coding apparatus 2 quantizes the transform coefficient (QP=2^{qp/6}).

(PU Split Type)

The PU split type (PartMode) includes the following eight types of patterns in total on the assumption that the size of a target CU is 2N×2N pixels. That is, there are four symmetric splittings including 2N×2N pixels, 2N×N pixels, N×2N pixels, and N×N pixels, and four asymmetric splittings including 2N×nU pixels, 2N×nD pixels, nL×2N pixels, and nR×2N pixels. N indicates 2^{m} (where m is an integer of 1 or more). A region obtained by splitting a symmetric CU is also referred to as a partition below.

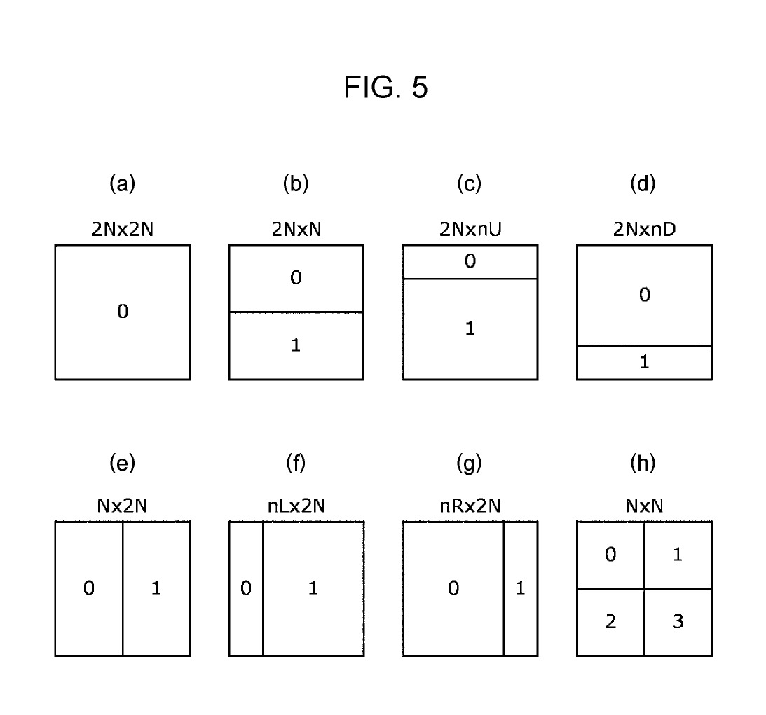

FIGS. 5(a) to 5(h) specifically illustrate positions of boundaries of PU split in a CU, for respective split types.

FIG. 5(a) illustrates a PU split type of 2N×2N in which a CU is not split.

FIGS. 5(b), 5(c) and 5(d) illustrate shapes of partitions in cases where PU split types are 2N×N, 2N×nU, and 2N×nD, respectively. Partitions in cases where PU split types are 2N×N, 2N×nU, and 2N×nD are collectively referred to as a transversely long partition.

FIGS. 5(e), 5(f), and 5(g) illustrate shapes of partitions in cases where PU split types are N×2N, nL×2N, and nR×2N, respectively. Partitions in cases where PU split types are N×2N, nL×2N, and nR×2N are collectively referred to as a longitudinally long partition.

The transversely long partition and the longitudinally long partition are collectively referred to as a rectangular partition.

FIG. 5(h) illustrates a shape of a partition in a case where a PU split type is N×N. The PU split types of FIGS. 5(a) and 5(h) are also referred to as square split on the basis of the shape of the partition. The PU split types of FIGS. 5(b) to 5(g) are also referred to as non-square split.

In FIGS. 5(a) to 5(h), a number assigned to each region indicates an identification number of the region, and processing is performed on the regions in an order of the identification numbers. That is, the identification number indicates a scan order of the region.

It is assumed that the upper left part is a reference point (origin) of a CU in FIGS. 5(a) to 5(h).

[Split Type in Case of Inter-Prediction]

In an inter-PU, seven types other than N×N (FIG. 5(h)) among the above eight split types are defined. The four asymmetric splittings may be referred to as asymmetric motion partition (AMP). Generally, a CU split by asymmetric partition includes partitions having different shapes or sizes. Symmetric splitting may be referred to as symmetric partition. Generally, a CU split by symmetric partition includes partitions having the same shape and size.

A specific value of the above-described N is prescribed by a size of a CU to which a corresponding PU belongs, and specific values of nU, nD, nL, and nR are determined in accordance with the value of N. For example, an inter-CU of 128×128 pixels can be split into inter-PUs of 128×128 pixels, 128×64 pixels, 64×128 pixels, 64×64 pixels, 128×32 pixels, 128×96 pixels, 32×128 pixels, and, and 96×128 pixels.

[Split Type in Case of Intra-Prediction]

The following two split patterns are defined in an intra-PU. That is, there are a split pattern 2N×2N in which a target CU is not split, that is, the target CU is treated as a single PU, and a pattern N×N in which the target CU is symmetrically split into four PUs.

Thus, in the intra-PU, the split patterns of FIGS. 5(a) and 5(h) can be taken in the examples illustrated in FIG. 5.

For example, an intra-CU of 128×128 pixels can be split into PUs of 128×128 pixels and 64×64 pixels.

In a case of an I slice, the coding unit information CU may include an intra-split mode (intra_part_mode) for specifying a PU split type (PartMode).

[Video Decoding Apparatus]

A configuration of the video decoding apparatus 1 according to the embodiment will be described below with reference to FIGS. 1 to 23.

(Outline of Video Decoding Apparatus)

The video decoding apparatus 1 generates a predicted image for each PU. The video decoding apparatus 1 generates decoded image #2 by adding the generated predicted image and prediction residual decoded from coded data #1. The video decoding apparatus 1 outputs the generated decoded image #2 to the outside of the apparatus 1.

Here, the predicted image is generated with reference to a coding parameter obtained by decoding the coded data #1. The coding parameter is a parameter which is referred in order to generate a predicted image. The coding parameter includes the shape or the size of a PU, the size or the shape of a block, residual data between an original image and a predicted image, and the like in addition to prediction parameters such as a motion vector referred in inter-frame prediction (also referred to as intra-prediction) and a prediction mode referred in intra-frame prediction. A set of all pieces of information except for the residual data among pieces of information included in the coding parameter is referred to as side information.

In the following descriptions, it is assumed that a picture (frame), a slice, a tree block, a block, and a PU which serve as a target of decoding are respectively referred to as a target picture, a target slice, a target tree block, a target block, and a target PU.

The size of a tree block is, for example, 64×64 pixels. The size of a PU is, for example, 64×64 pixels, 32×32 pixels, 16×16 pixels, 8×8 pixels, 4×4 pixels, or the like. These sizes are just examples, and the size of a tree block and the size of a PU may be sizes other than the above-described sizes.

(Configuration of Video Decoding Apparatus)

The schematic configuration of the video decoding apparatus 1 will be described with reference to FIG. 2, as follows. FIG. 2 is a functional block diagram schematically illustrating a configuration of the video decoding apparatus 1.

As illustrated in FIG. 2, the video decoding apparatus 1 includes a decoding module 10, a CU information decoding unit 11, a PU information decoding unit 12, a TU information decoding unit 13, a predicted image generation unit 14, an inverse quantization and inverse transform unit 15, a frame memory 16, and an adder 17.

[Basic Decoding Flow]

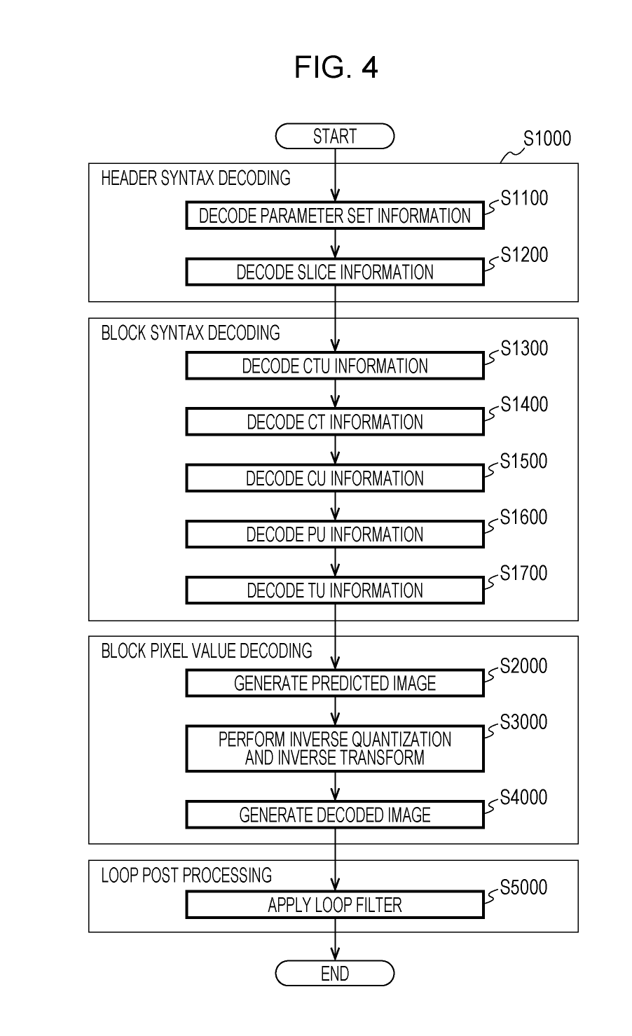

FIG. 4 is a flowchart schematically illustrating an operation of the video decoding apparatus 1.

(S1100) The decoding module 10 decodes parameter set information such as an SPS and a PPS, from coded data #1.

(S1200) The decoding module 10 decodes a slice header (slice information) from the coded data #1.

Then, the decoding module 10 derives a decoded image of each CTB by repeating processes of S1300 to S4000 on each CTB included in a target picture.

(S1300) The CU information decoding unit 11 decodes coding tree unit information (CTU information) from the coded data #1.

(S1400) The CU information decoding unit 11 decodes coding tree information (CT information) from the coded data #1.

(S1500) The CU information decoding unit 11 decodes coding unit information (CU information) from the coded data #1.

(S1600) The PU information decoding unit 12 decodes prediction unit information (PT information PTI) from the coded data #1.

(S1700) The TU information decoding unit 13 decodes transform unit information (TT information TTI) from the coded data #1.

(S2000) The predicted image generation unit 14 generates a predicted image for each PU included in the target CU, based on the PT information PTI.

(S3000) The inverse quantization and inverse transform unit 15 performs inverse quantization and inverse transform processing on each TU included in the target CU, based on the TT information TTI.

(S4000) The adder 17 adds a predicted image Pred supplied by the predicted image generation unit 14 and prediction residual D supplied by the inverse quantization and inverse transform unit 15, and thus the decoding module 10 generates a decoded image P for the target CU.

(S5000) The decoding module 10 applies a loop filter such as a deblocking filter or a sample adaptive filter (SAO), to the decoded image P.

A schematic operation of each module will be described below. [Decoding Module]

The decoding module 10 performs decoding processing of decoding a syntax value from binary. More specifically, the decoding module 10 decodes the syntax value coded by an entropy coding method such as CABAC and CAVLC, based on coded data and a syntax type which are supplied from a supply source. Then, the decoding module 10 brings the decoded syntax value back into the supply source.

In the example which will be described below, the supply source of the coded data and the syntax type is the CU information decoding unit 11, the PU information decoding unit 12, and the TU information decoding unit 13.

[CU Information Decoding Unit]

The CU information decoding unit 11 performs decoding processing on coded data #1 which is input from the video coding apparatus 2 and corresponds to one frame, at a level of a tree block and a CU. The decoding processing is performed by using the decoding module 10. Specifically, the CU information decoding unit 11 decodes CTU information, CT information, CU information, PT information PTI, and TT information TTI from the coded data #1 through the following procedures.

Firstly, the CU information decoding unit 11 subsequently divides coded data #1 into slices and tree blocks, with reference to various headers included in the coded data #1.

Here, the various headers include (1) information regarding a split method of a target picture into slices and (2) information regarding the size and the shape of a tree block belonging to a target slice and regarding the position of the tree block in the target slice.

The CU information decoding unit 11 decodes tree block split information SP_CTU included in a tree block header CTUH, as CT information. Then, the CU information decoding unit 11 splits a target tree block into CUs. Then, the CU information decoding unit 11 acquires coding unit information (referred to as CU information below) corresponding to CUs which are obtained by splitting. The CU information decoding unit 11 performs decoding processing of CU information corresponding to a target CU by sequentially using CUs included in the tree block, as the target CU.

The CU information decoding unit 11 performs demultiplexing of TT information TTI (regarding a transform tree which is obtained for the target CU) and PT information PTI (regarding a prediction tree which is obtained for the target CU).

As described above, the TT information TTI includes TU information TUI corresponding to a TU which is included in a transform tree. As described above, the PT information PTI includes PU information PUI corresponding to a PU included in a target prediction tree.

The CU information decoding unit 11 supplies the PT information PTI obtained for the target CU, to the PU information decoding unit 12. The CU information decoding unit 11 supplies the TT information TTI obtained for the target CU to the TU information decoding unit 13.

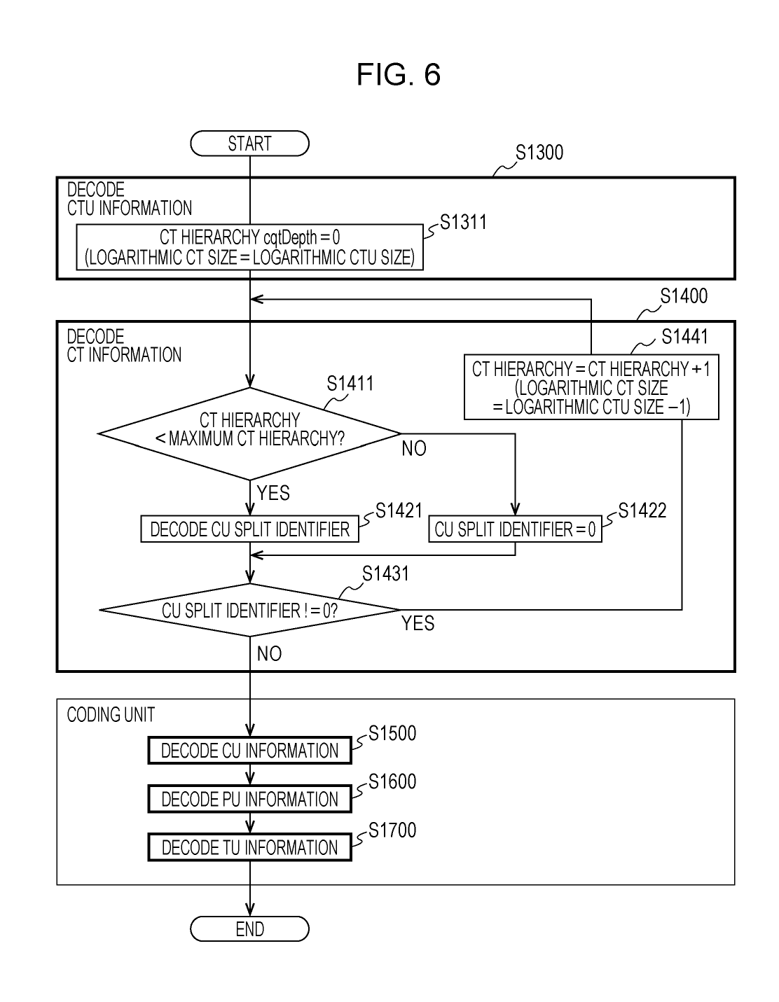

More specifically, the CU information decoding unit 11 performs the following operation as illustrated in FIG. 6. FIG. 6 is a flowchart schematically illustrating an operation of the CU information decoding unit 11 (CTU information decoding S1300 and CT information decoding S1400) according to the embodiment of the present invention.

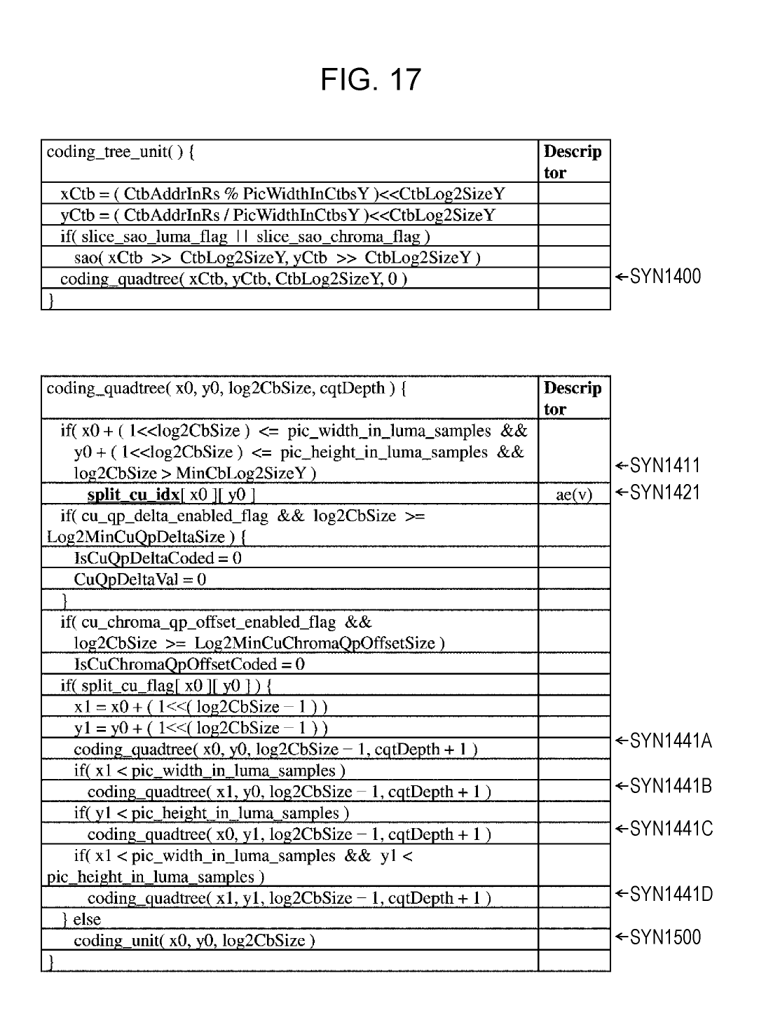

FIG. 17 is a diagram illustrating a configuration example of a syntax table of CU information according to the embodiment of the present invention.

(S1311) The CU information decoding unit 11 decodes CTU information from the coded data #1 and initializes variables for managing a coding tree CT which is recursively split. Specifically, as represented by the following expression, the CU information decoding unit 11 sets a CT level (CT depth, CU level, CU depth, split depth) cqtDepth indicating the level of a coding tree, to 0. The CU information decoding unit 11 sets a CTB size Ctb Log 2SizeY(Ctb Log 2Size) which is the size of a coding tree block, as a CU size (here, logarithmic CU size log 2CbSize=size of transform tree block) which is a coding unit size.

cqtDepth=0

log 2CbSize=Ctb Log 2SizeY

It is assumed that the CT level (CT depth) cqtDepth is set to 0 at the highest level, and is increased one by one as the lower layer becomes deeper. However, it is not limited thereto. In the above descriptions, the CU size and the CTB size are limited to exponentiation (4, 8, 16, 32, 64, 128, 256, and the like) of 2, and thus the size of the block is handled in a manner of logarithm with 2 as a base. However, it is not limited thereto. In a case where the block size is 4, 8, 16, 32, 64, 128, and 256, 2, 3, 4, 5, 6, 7, and 8 are respectively logarithmic values.

The CU information decoding unit 11 recursively decodes the coding tree TU(coding_quadtree) (S1400). The CU information decoding unit 11 decodes a coding tree coding_quadtree (xCtb, yCtb, Ctb Log 2SizeY, 0) on the top (root) (SYN1400). xCtb and yCtb indicate the upper left coordinates of a CTB. Ctb Log 2SizeY indicates the block size (for example, 64, 128, and 256) of the CTB.

(S1411) The CU information decoding unit 11 determines whether or not the logarithmic CU size log 2CbSize is greater than the predetermined minimum CU size MinCb Log 2SizeY (minimum transform block size) (SYN1411). In a case where the logarithmic CU size log 2CbSize is greater than MinCb Log 2SizeY, the process proceeds to S1421. In other cases, the process proceeds to S1422.

(S1421) The CU information decoding unit 11 decodes a CU split flag (split cu flag) which is a syntax element shown in SYN1421, in a case where the logarithmic CU size log 2CbSize is greater than MinCb Log 2SizeY.

(S1422) The CU information decoding unit 11 omits decoding of a CU split identifier split_cu_idx from the coded data #1 and derives the CU split identifier split_cu_idx to be 0, in other cases (case where the logarithmic CU size log 2CbSize is equal to or smaller than MinCb Log 2SizeY), that is, in a case where the CU split identifier split_cu_idx is not shown from the coded data #1.

(S1431) The CU information decoding unit 11 decodes one or more coding trees included in the target coding tree, in a case where the CU split identifier split_cu_idx is not 0 (that is, 1) (SYN1431). Here, the CU information decoding unit 11 decodes four lower coding trees CT having positions of (x0, y0), (x1, y0), (x0, y1), and (x1, y1) which correspond to the (logarithmic CT size log 2CbSize−1) and (CT level cqtDepth+1). The CU information decoding unit 11 also continues the CT decoding processing S1400 started from S1411, on the lower coding tree CT.

coding_quadtree (x0, y0, log 2CbSize−1, cqtDepth+1) (SYN1441A)

coding_quadtree (x1, y0, log 2CbSize−1, cqtDepth+1) (SYN1441B)

coding_quadtree (x0, y1, log 2CbSize−1, cqtDepth+1) (SYN1441C)

coding_quadtree (x1, y1, log 2CbSize−1, cqtDepth+1) (SYN1441D)

Here, x0 and y0 indicate the upper left coordinates of the target coding tree. x1 and y1 indicate coordinates derived by adding the half of the target CT size (1<<log 2CbSize) to the CT coordinates, as represented by the following equation.

x1=x0+(1<<(log 2CbSize−1))

y1=y0+(1<<(log 2CbSize−1))

“<<” indicates left shift left. 1<<N means the same value as 2N (this is also the same for the following). Similarly, “>>” indicates right shift.

In other cases (case where the CU split flag split cu flag is 0), the process proceeds to S1500 in order to decode a coding unit.

(S1441) As described above, before a coding tree coding_quadtree is recursively decoded, 1 is added to the CT level cqtDepth indicating the level of the coding tree and 1 is subtracted from the logarithmic CU size log 2CbSize which is the coding unit size (divides the coding unit size in half), in accordance with the following equation. Then, updating is performed.

cqtDepth=cqtDepth+1

log 2CbSize=log 2CbSize−1

(S1500) The CU information decoding unit 11 decodes a coding unit CU coding_unit(x0, y0, log 2CbSize) (SYN1450). Here, x0 and y0 indicate coordinates of the coding unit. Here, log 2CbSize which is the size of the coding tree is equal to the size of the coding unit.

[PU Information Decoding Unit]

The PU information decoding unit 12 performs decoding processing on PT information PTI which is supplied from the CU information decoding unit 11, at a level of a PU. The decoding processing is performed by using the decoding module 10. Specifically, the PU information decoding unit 12 decodes the PT information PTI through the following procedures.

The PU information decoding unit 12 determines a PU split type in a target prediction tree, with reference to PU split type information Part_type. The PU information decoding unit 12 performs decoding processing of PU information corresponding to a target PU by using sequentially using PUs included in the target prediction tree, as the target PU.

That is, the PU information decoding unit 12 performs decoding processing of each parameter which is used for generating a predicted image, from the PU information corresponding to the target PU.

The PU information decoding unit 12 supplies the PU information decoded for the target PU, to the predicted image generation unit 14.

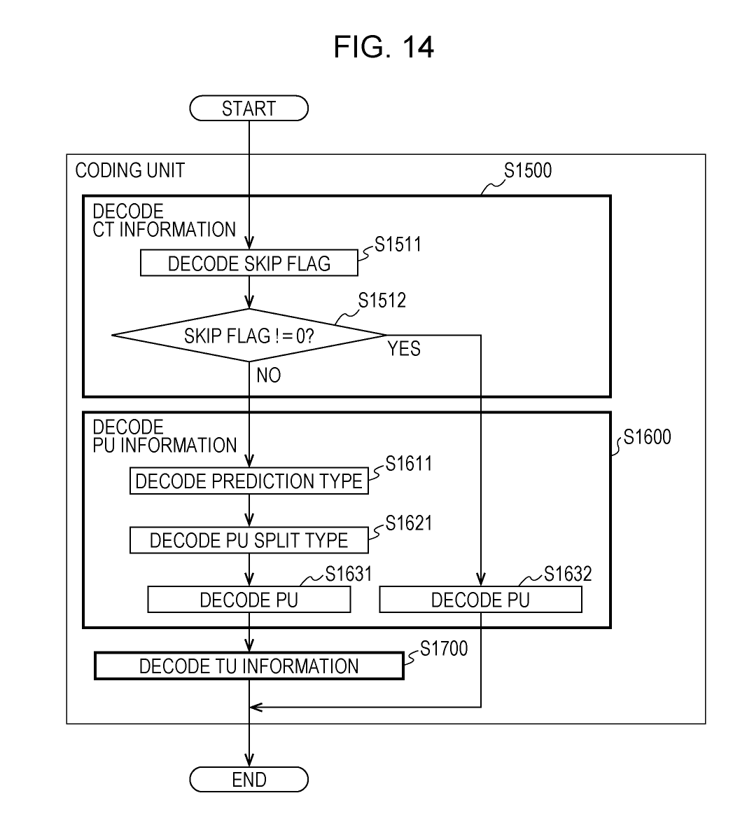

More specifically, the CU information decoding unit 11 and the PU information decoding unit 12 perform the following operation as illustrated in FIG. 14. FIG. 14 is a flowchart schematically illustrating an operation of decoding the PU information, which is described in S1600.

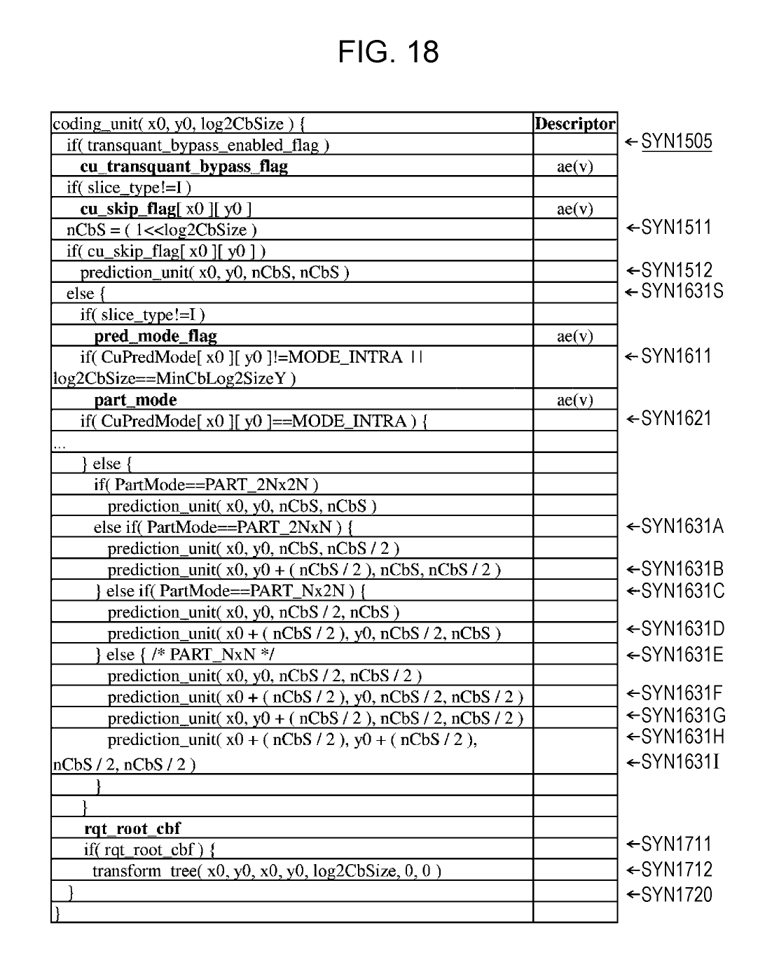

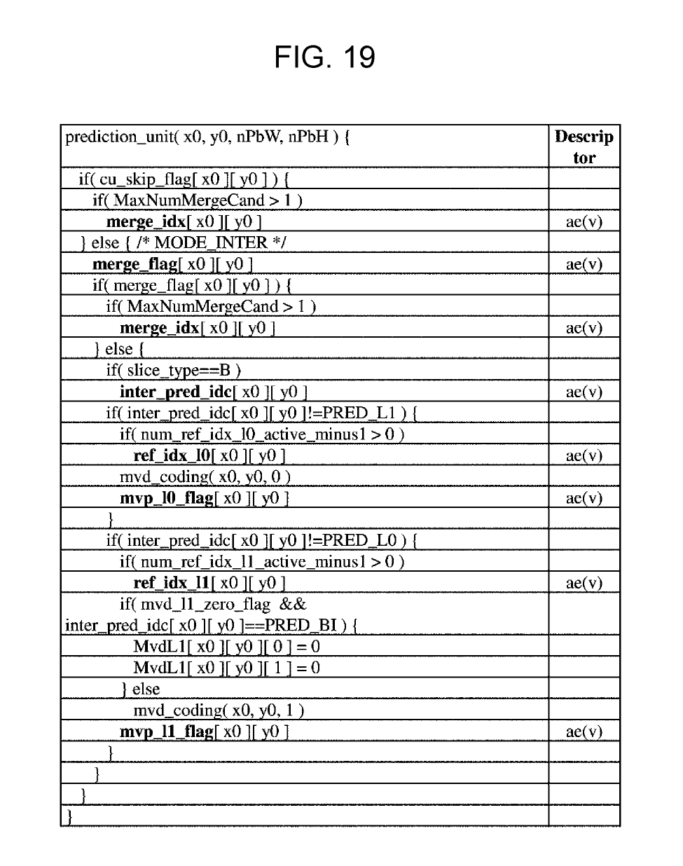

FIG. 18 is a diagram illustrating a configuration example of a syntax table of CU information, PT information PTI, and TT information TTI according to the embodiment of the present invention. FIG. 19 is a diagram illustrating a configuration example of a syntax table of PT information PTI according to the embodiment of the present invention.

S1511 The CU information decoding unit 11 decodes a skip flag skip_flag from the coded data #1.

S1512 The CU information decoding unit 11 determines whether or not the skip flag skip_flag is not 0 (that is, 1). In a case where the skip flag skip_flag is not 0 (that is, 1), the PU information decoding unit 12 omits decoding of CU prediction method information PredMode (which is a prediction type Pred_type from the coded data #1) and PU split type information PartMode, and derives inter-prediction and not-splitting (2N×2N). In addition, in a case where the skip flag skip flag is not 0 (that is, 1), the TU information decoding unit 13 omits decoding processing of TT information TTI from the coded data #1, which is described in S1700, and derives that the target CU is not subjected to TU splitting and quantized prediction residual TransCoeffLevel[][]of the target CU is 0.

S1611 The PU information decoding unit 12 decodes CU prediction method information PredMode(syntax element pred_mode_flag) from the coded data #1.

S1621 The PU information decoding unit 12 decodes PU split type information PartMode(syntax element part_mode) from the coded data #1.

S1631 The PU information decoding unit 12 decodes pieces of PU information which are included in the target CU and correspond to the number of split of a PU, which is indicated by the PU split type information Part_type, from the coded data #1.

For example, in a case where the PU split type indicates 2N×2N, the PU information decoding unit 12 decodes one piece of PU information PUI indicating that a CU is set to be one PU as follows.

prediction_unit(x0, y0, nCbS, nCbS) (SYN1631A)

In a case where the PU split type indicates 2N×N, the PU information decoding unit 12 decodes two pieces of PU information PUI indicating that a CU is vertically split as follows.

prediction_unit(x0, y0, nCbS, nCbS) (SYN1631B)

prediction_unit(x0, y0+(nCbS/2), nCbS, nCbS/2) (SYN1631C)

In a case where the PU split type is N×2N, the PU information decoding unit 12 decodes two pieces of PU information PUI indicating that a CU is transversely split as follows.

prediction_unit(x0, y0, nCbS, nCbS) (SYN1631D)

prediction_unit(x0+(nCbS/2), y0, nCbS/2, nCbS) (SYN1631E)

In a case where the PU split type is N×N, the PU information decoding unit 12 decodes four pieces of PU information PUI indicating that a CU is split into four equal parts as follows.

prediction_unit(x0, y0, nCbS, nCbS) (SYN1631F)

prediction_unit(x0+(nCbS/2), y0, nCbS/2, nCbS) (SYN1631G)

prediction_unit(x0, y0+(nCbS/2), nCbS, nCbS/2) (SYN1631H)

prediction_unit(x0+(nCbS/2), y0+(nCbS/2), nCbS/2, nCbS/2) (SYN1631I)

S1632 In a case where the skip flag is 1, the PU information decoding unit 12 sets the PU split type to be 2N×2N and decodes one piece of PU information PUI.

prediction_unit(x0, y0, nCbS, nCbS) (SYN1631S)

S1700 FIG. 14 is a flowchart schematically illustrating an operation of the CU information decoding unit 11 (CU information decoding S1500), a PU information decoding unit 12 (PU information decoding S1600), and a TU information decoding unit 13 (TT information decoding S1700), according to the embodiment of the present invention.

[TU Information Decoding Unit]

The TU information decoding unit 13 performs decoding processing on TT information TTI which is supplied from the CU information decoding unit 11, at a level of a TU. The decoding processing is performed by using the decoding module 10. Specifically, the TU information decoding unit 13 decodes the TT information TTI through the following procedures.

The TU information decoding unit 13 splits a target transform tree into nodes or TUs with reference to TT split information SP_TU. The TU information decoding unit 13 performs recursive splitting processing on a target node if additional splitting is designated.

If the splitting processing is ended, the TU information decoding unit 13 performs decoding processing of TU information corresponding to a target TU, by sequentially using TUs included in the target prediction tree, as the target TU.

That is, the TU information decoding unit 13 performs decoding processing of each parameter used for recovering a transform coefficient, from the TU information corresponding to the target TU.

The TU information decoding unit 13 supplies TU information decoded for the target TU, to the inverse quantization and inverse transform unit 15.

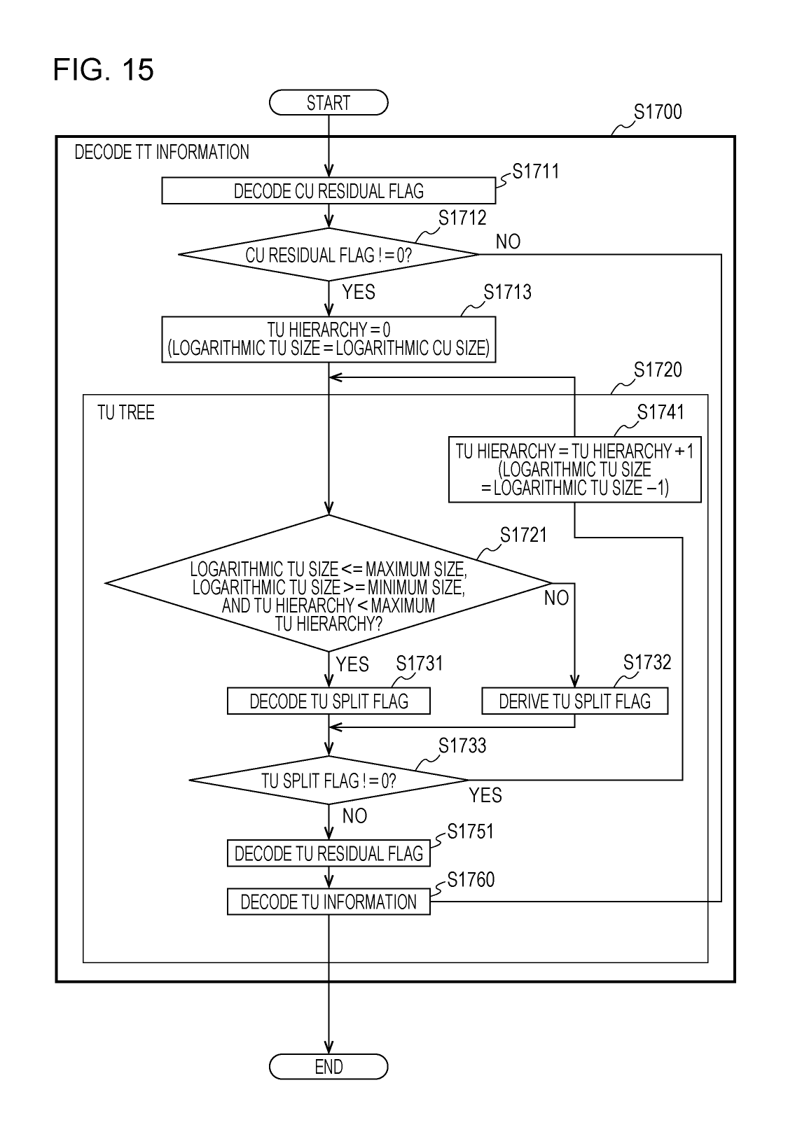

More specifically, the TU information decoding unit 13 performs the following operation as illustrated in FIG. 15. FIG. 15 is a flowchart schematically illustrating an operation of the TU information decoding unit 13 (TT information decoding S1700), according to the embodiment of the present invention.

(S1711) The TU information decoding unit 13 decodes a CU residual flag rqt_root_cbf (syntax element described in SYN1711) from the coded data #1. The CU residual flag rqt_root_cbf indicates whether or not a target CU has residual (quantized prediction residual) having a value other than 0.

(S1712) The TU information decoding unit 13 causes the process to proceed to S1721 in order to decode a TU, in a case where the CU residual flag rqt_root_cbf is not 0 (that is, 1) (SYN1712). Conversely, in a case where the CU residual flag rqt_root_cbf is 0, the TU information decoding unit 13 omits processing of decoding TT information TTI of the target CU from the coded data #1. The TU information decoding unit 13 derives that the target CU is not subjected to TU splitting and the quantized prediction residual of the target CU is 0, as the TT information TTI.

(S1713) The TU information decoding unit 13 initializes variables for managing a transform tree which is recursively split. Specifically, as represented by the following equation, the TU information decoding unit 13 sets a TU level trafoDepth indicating the level of a transform tree, to 0. The TU information decoding unit 13 sets the size of a coding unit (here, logarithmic CT size log 2CbSize) as a TU size (here, logarithmic TU size log 2TrafoSize) which is a transform unit size.

trafoDepth=0

log 2TrafoSize=log 2CbSize

Then, the TU information decoding unit 13 decodes a transform tree transform tree (x0, y0, x0, y0, log 2CbSize, 0, 0) on the top (root) (SYN1720). Here, x0 and y0 indicate coordinates of the target CU.

The TU information decoding unit 13 recursively decodes the transform tree TU(transform_tree) (S1720). The transform tree TU is split such that the size of a leaf node (transform block) obtained by recursive splitting is a predetermined size. That is, the transform tree TU is split such that the size of a leaf node is from the minimum size MinTb Log 2SizeY of transform to the maximum size MaxTb Log 2SizeY thereof.

(S1721) A TU split flag decoding unit in the TU information decoding unit 13 determines whether the target TU size (for example, logarithmic TU size log 2TrafoSize) is in a predetermined range (here, greater than MinTb Log 2SizeY and MaxTb Log 2SizeY or smaller) of a transform size. In a case where the level trafoDepth of the target TU is lower than a predetermined level MaxTrafoDepth, the TU split flag decoding unit decodes a TU split flag (split transform flag). More specifically, in a case where the logarithmic TU size log 2TrafoSize <=the maximum TU size MaxTb Log 2SizeY, the logarithmic TU size log 2TrafoSize >the minimum TU size MinTb Log 2SizeY, and the TU level trafoDepth <the maximum TU level MaxTrafoDepth, the TU split flag decoding unit decodes the TU split flag (split transform flag).

(S1731) The TU split flag decoding unit in the TU information decoding unit 13 decodes the TU split flag split_transform_flag in accordance with the condition of S1721.

(S1732) In other cases, that is, in a case where split_transform_flag is not shown in the coded data #1, the TU split flag decoding unit in the TU information decoding unit 13 omits decoding of the TU split flag split transform flag from the coded data #1. In a case where the logarithmic TU size log 2TrafoSize is greater than the maximum TU size MaxTb Log 2SizeY, the TU split flag decoding unit derives the TU split flag split transform flag to indicate splitting (that is, 1). In other cases (case where the logarithmic TU size log 2TrafoSize is equal to the minimum TU size MaxTb Log 2SizeY or the TU level trafoDepth is equal to the maximum TU level MaxTrafoDepth), the TU split flag decoding unit derives the TU split flag split_transform_flag to indicate not-splitting (that is, 0).

(S1741) In a case where the TU split flag split_transform_flag has a value (that is, 1) other than 0, which indicates splitting, the TU split flag decoding unit in the TU information decoding unit 13 decodes a transform tree included in the target coding unit CU. Here, the TU split flag decoding unit decodes four lower transform trees TT having positions of (x0, y0), (x1, y0), (x0, y1), and (x1, y1) which correspond to the (logarithmic CT size log 2CbSize−1) and (TU level trafoDepth+1). The TU information decoding unit 13 also continues the TT information decoding processing S1700 started from S1711, on the lower coding tree TT.

transform tree (x0, y0, x0, y0, log 2TrafoSize−1, trafoDepth+1, 0) (SYN1741A)

transform tree (x1, y0, x0, y0, log 2TrafoSize−1, trafoDepth+1, 1) (SYN1741B)

transform tree (x0, y1, x0, y0, log 2TrafoSize−1, trafoDepth+1, 2) (SYN1741C)

transform tree (x1, y1, x0, y0, log 2TrafoSize−1, trafoDepth+1, 3) (SYN1741D)

Here, x0 and y0 indicate the upper left coordinates of the target transform tree. x1 and y1 indicate coordinates derived by adding the half of the target TU size (1<<log 2TrafoSize) to the transform tree coordinates (x0, y0), as represented by the following equation.

x1=x0+(1<<(log 2TrafoSize−1))

y1=y0+(1<<(log 2TrafoSize−1))

In other cases (case where the TU split flag split_transform_flag is 0), the process proceeds to S1751 in order to decode a transform unit.

As described above, before a transform tree transform tree is recursively decoded, 1 is added to the TU level trafoDepth indicating the level of the transform tree and 1 is subtracted from the logarithmic CT size log 2TrafoSize which is the target TU size, in accordance with the following equation. Then, updating is performed.

trafoDepth=trafoDepth+1

log 2TrafoSize=log 2TrafoSize−1

(S1751) In a case where the TU split flag split transform flag is 0, the TU information decoding unit 13 decodes a TU residual flag indicating whether residual is included in the target TU. Here, a luminance residual flag cbf_luma is used as the TU residual flag. However, it is not limited thereto. The luminance residual flag cbf_luma indicates whether residual is included in a luminance component of a target TU.

(S1760) In a case where the TU split flag split_transform_flag is 0, the TU information decoding unit 13 decodes a transform unit TUtransform unit(x0, y0, xBase, yBase, log 2TrafoSize, trafoDepth, blkIdx) described in SYN1760.

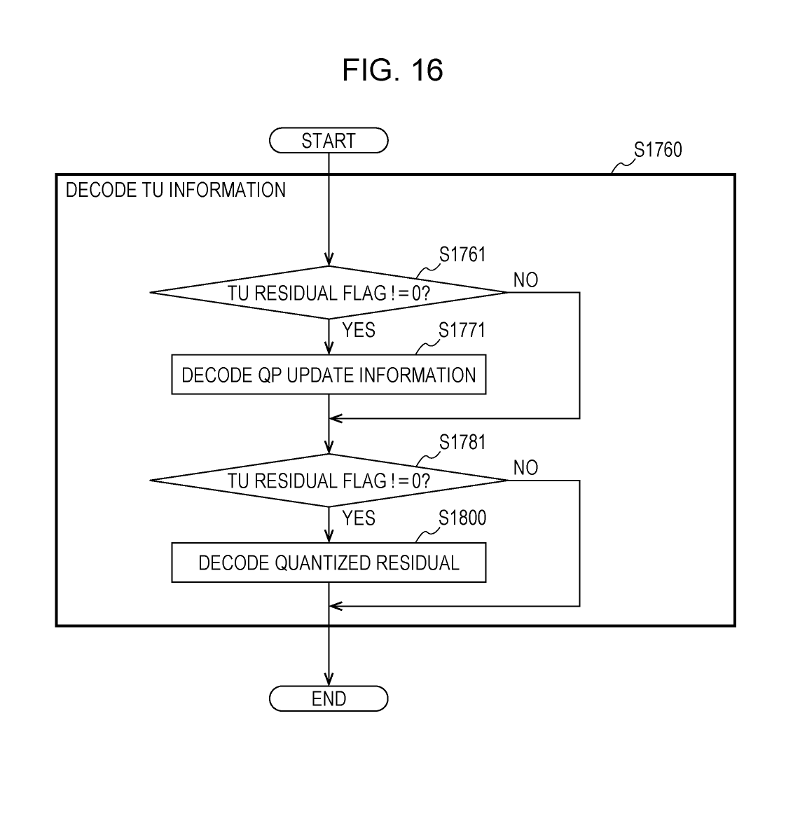

FIG. 16 is a flowchart schematically illustrating an operation of the TU information decoding unit 13 (TU information decoding S1600), according to the embodiment of the present invention.

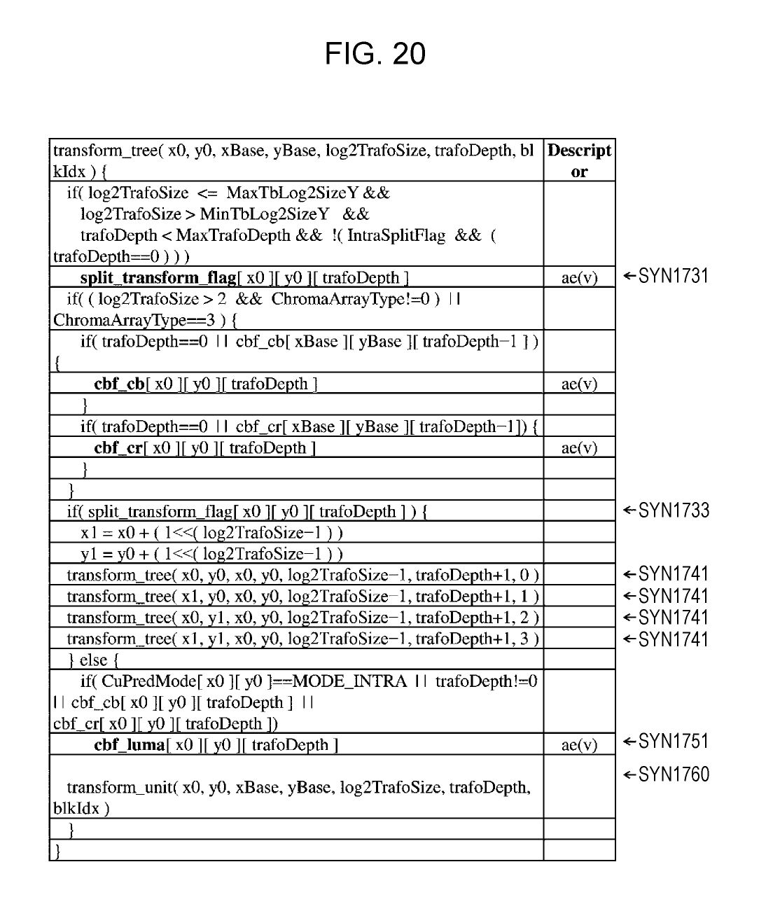

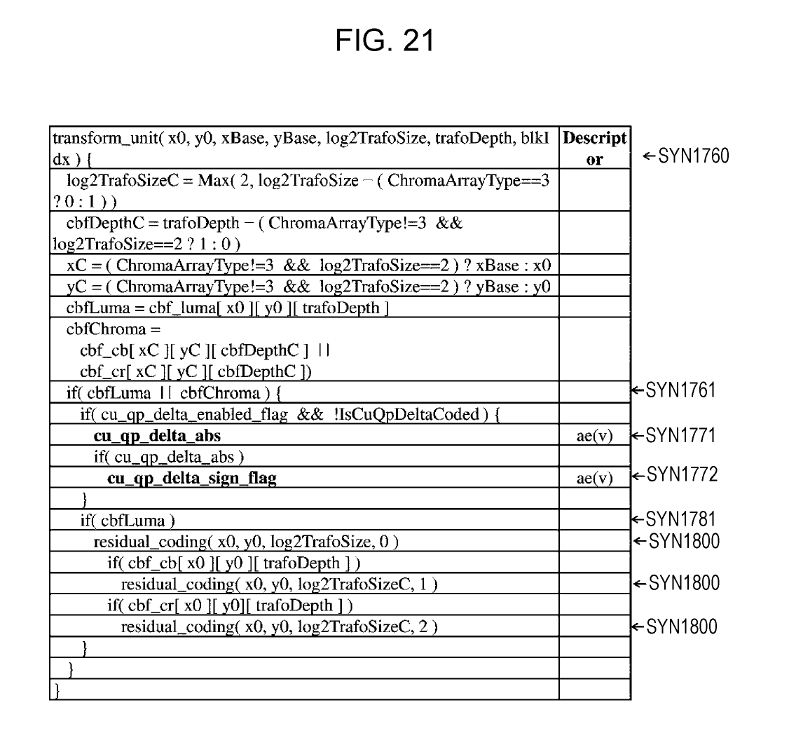

FIG. 20 is a diagram illustrating a configuration example of a syntax table of TT information TTI according to the embodiment of the present invention. FIG. 21 is a diagram illustrating a configuration example of a syntax table of TU information according to the embodiment of the present invention.

(S1761) The TU information decoding unit 13 determines whether residual is included in a TU (whether or not the TU residual flag is not 0). Here (SYN1761), whether the residual is included in a TU is determined by cbfLuma || cbfChroma derived in the following equation. However, it is not limited thereto. That is, a luminance residual flag cbf_luma indicating whether residual is included in a luminance component of a target TU may be used as the TU residual flag.

cbfLuma=cbf_luma[x0][y0][trafoDepth]

cbfChroma=cbf_cb [xC][yCilcbfDepthC]|| cbf_cr [xC][yC][cbfDepthC])

cbf_cb and cbf_cr are flags decoded from the coded data #1, and indicate whether residual is included in chrominance components Cb and Cr of the target TU. || indicates OR. Here, a TU residual flag cbfLuma of luminance and a TU residual flag cbfChroma of chrominance are derived from a luminance position (x0, y0) of a TU, a chrominance position (xC, yC) thereof, a TU depth trafoDepth, and syntax elements cbf luma, cbf_cb, and cbf_cr of cfbDepthC. The sum (OR) is derived as the TU residual flag of the target TU.

(S1771) In a case where residual is included in a TU (in a case where the TU residual flag is not 0), the TU information decoding unit 13 decodes QP update information (quantized correction value). Here, the QP update information has a value indicating a difference value from a quantization parameter prediction value qPpred which is a prediction value of the quantization parameter QP. Here, the difference value is decoded from an absolute value cu_qp_delta_abs and a code cu_qp_delta_sign_flag as the syntax element of the coded data. However, it is not limited thereto.

(S1781) The TU information decoding unit 13 determines whether or not the TU residual flag (here, cbfLuma) is not 0.

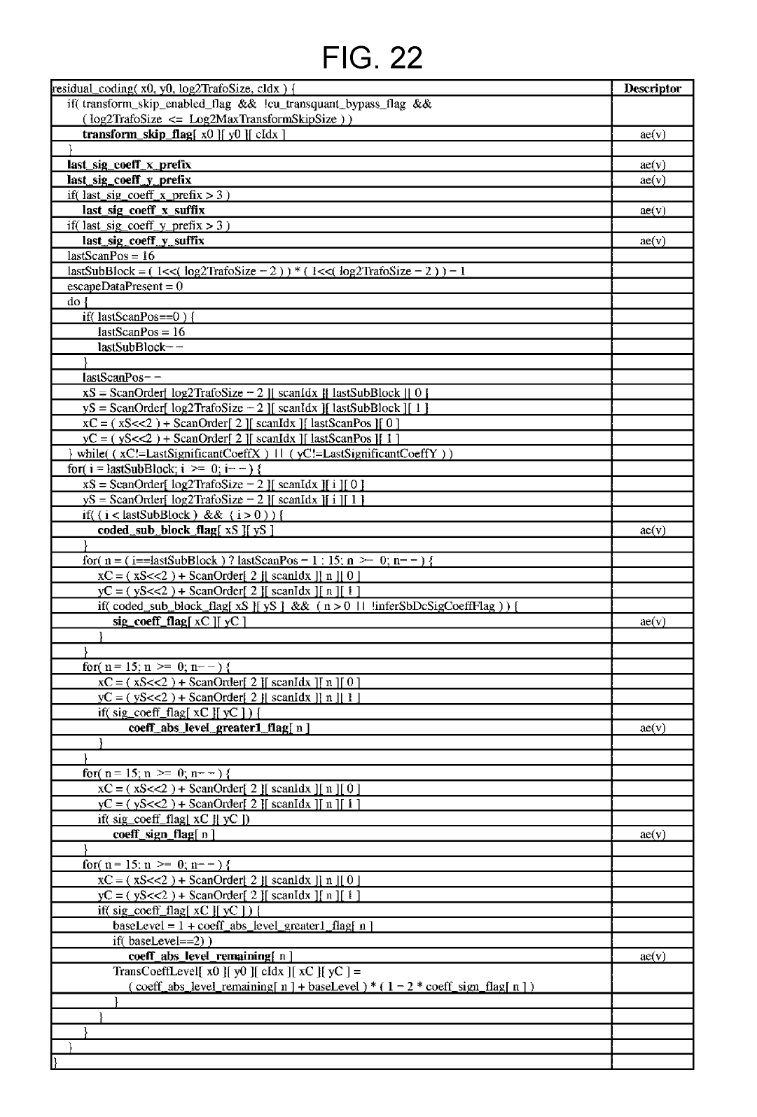

(S1800) In a case where the TU residual flag (here, cbfLuma) is not 0, the TU information decoding unit 13 decodes the quantized prediction residual. The TU information decoding unit 13 may sequentially decode a plurality of color components as the quantized prediction residual. In the example in FIG. 21, in a case where the TU residual flag (here, cbfLuma) is not 0, the TU information decoding unit 13 decodes luminance quantized prediction residual (first color component) residual_coding (x0, y0, log 2TrafoSize, 0). In a case where a second color component residual flag cbf cb is not 0, the TU information decoding unit 13 decodes residual_coding (x0, y0, log 2TrafoSize, 1), and a third color component quantized prediction residual residual_coding (x0, y0, log 2TrafoSizeC, 2). FIG. 22 illustrates an example of a syntax table of the quantized prediction residual residual_coding (x0, y0, log 2TrafoSize, cIdx). The TU information decoding unit 13 decodes each piece of syntax in accordance with the syntax table in FIG. 22.

[Predicted Image Generation Unit]

The predicted image generation unit 14 generates a predicted image for each PU included in the target CU, based on the PT information PTI. Specifically, the predicted image generation unit 14 generates a predicted image Pred from a local decoded image P′ which is a decoded image, in a manner that the predicted image generation unit 14 performs intra-prediction or inter-prediction on each target PU included in the target prediction tree, in accordance with parameters which are included in the PU information PUI corresponding to the target PU. The predicted image generation unit 14 supplies the generated predicted image Pred to the adder 17.

A method in which the predicted image generation unit 14 generates a predicted image of a PU included in the target CU, based on motion compensation prediction parameters (motion vector, reference image index, and inter-prediction flag) will be described as follows.

In a case where the inter-prediction flag indicates uni-prediction, the predicted image generation unit 14 generates a predicted image corresponding to a decoded image which is positioned at a place indicated by a motion vector of a reference image indicated by a reference image index.

In a case where the inter-prediction flag indicates bi-prediction, the predicted image generation unit 14 generates a predicted image by performing motion compensation on each combination of two sets of reference image indices and motion vectors. The predicted image generation unit 14 calculates an average or adds the weight to each predicted image based on a display time interval between a target picture and the reference image, and thus finally generates the predicted image.

[Inverse Quantization and Inverse Transform Unit]

The inverse quantization and inverse transform unit 15 performs inverse quantization and inverse transform processing on each TU included in the target CU, based on the TT information TTI. Specifically, the inverse quantization and inverse transform unit 15 restores a prediction residual D of each pixel in a manner that the inverse quantization and inverse transform unit 15 performs inverse quantization and inverse orthogonal transform on quantized prediction residual included in TU information TUI corresponding to a target TU, regarding each target TU included in the target transform tree. Here, the orthogonal transform means orthogonal transform from a pixel domain to a frequency domain. Thus, the inverse orthogonal transform means transform from the frequency domain to the pixel domain. Examples of the inverse orthogonal transform include inverse discrete cosine transform and inverse discrete sine transform. The inverse quantization and inverse transform unit 15 supplies the restored prediction residual D to the adder 17.

[Frame Memory]

Decoded images P which have been decoded are sequentially recorded in the frame memory 16 along with parameters used for decoding the corresponding decoded image P. Decoded images corresponding to all tree blocks (for example, all tree blocks which precedes a target tree block in an order of raster scan) which have been decoded ahead of the target tree block at a time point when the target tree block is decoded are recorded in the frame memory 16. Examples of a decoding parameter recorded in the frame memory 16 include CU prediction method information (PredMode).

[Adder]

The adder 17 generates a decoded image P for the target CU by adding the predicted image Pred (supplied by the predicted image generation unit 14) and the prediction residual D (supplied by the inverse quantization and inverse transform unit 15). As will be described later, the adder 17 may perform processing of enlarging the decoded image P.

In the video decoding apparatus 1, a decoded image #2 corresponding to the coded data #1 which has been input to the video decoding apparatus 1 and corresponds to one frame is output to the outside of the apparatus 1 at a time point when decoded image generation processing on all tree blocks in an image, in a unit of a tree block, is ended.

### EXAMPLE 1

The video decoding apparatus 1 according to the present invention is an image decoding apparatus that splits a picture in a unit of a coding tree block and performs decoding. The video decoding apparatus 1 includes a coding tree split unit and includes an arithmetic decoding unit (CU split identifier decoding means). The coding tree split unit recursively splits a coding tree block as a coding tree of the root. The arithmetic decoding unit decodes the CU split identifier split_cu_idx [x0][y0] indicating whether or not the coding tree is split. Here, [x0][y0] indicates coordinates of the upper leftmost pixel of a coding tree (below, target CU).

FIG. 1 is a block diagram illustrating a configuration of an arithmetic decoding unit 191 (CU split identifier decoding means, arithmetic decoding device) that decodes the CU split identifier split_cu_idx [x0][y0]. As illustrated in FIG. 1, the arithmetic decoding unit 191 includes an arithmetic code decoding unit 115 and a CU split identifier decoding unit 113.

(Arithmetic Code Decoding Unit 115)

The arithmetic code decoding unit 115 has a configuration for decoding each bit included in coded data with reference to context. The arithmetic code decoding unit 115 includes a context recording and updating unit 116 and a bit decoding unit 117 as illustrated in FIG. 1.

(Context Recording and Updating Unit 116)

The context recording and updating unit 116 has a configuration for recording and updating a context variable CV which is managed by each context index ctxIdx associated with each piece of syntax. Here, the context variable CV includes (1) a superior symbol MPS (most probable symbol) of which an occurrence probability is high, and (2) a probability state index pStateIdx for designating an occurrence probability of the superior symbol MPS.

In a case where the supplied bypass flag BypassFlag indicates 0, that is, in a case where decoding is performed with reference to context, the context recording and updating unit 116 updates the context variable CV by referring the context index ctxIdx supplied from the CU split identifier decoding unit 113 and the value of a Bin decoded by the bit decoding unit 117, and the context recording and updating unit 116 records the updated context variable CV until updated next. In addition, the superior symbol MPS is 0 or 1. The superior symbol MPS and the probability state index pStateIdx are updated whenever the bit decoding unit 117 decodes one Bin.

In a case where the supplied bypass flag BypassFlag indicates 1, that is, in a case where decoding is performed by using a context variable CV in which occurrence probability of symbols 0 and 1 is fixed to be 0.5 (also referred to as a bypass mode), the context recording and updating unit 116 causes the occurrence probability of symbols 0 and 1 to be normally fixed to be 0.5 regarding the value of the context variable CV. In addition, the context recording and updating unit 116 omits update of the context variable CV.

The context index ctxIdx may directly designate a context regarding each Bin of each piece of syntax. The context index ctxIdx may be an increment value (context increment value) ctxInc from an offset which indicates a start value of a context index which is set for each piece of syntax.

(Bit Decoding Unit 117)

The bit decoding unit 117 decodes each bit included in coded data with reference to the context variable CV recorded in the context recording and updating unit 116. The bit decoding unit 117 supplies the value of a Bin obtained by decoding, to each constituent unit provided in a DC offset information decoding unit 111. The value of a Bin obtained by the decoding is also supplied to the context recording and updating unit 116 so as to be referred to for updating the context variable CV.

(CU Split Identifier Decoding Unit 113)

The CU split identifier decoding unit 113 further includes context index deriving means (not illustrated) and bypass flag deriving means (not illustrated). The context index deriving means derives a context index ctxIdx for determining a context used when the arithmetic code decoding unit 115 decodes a Bin corresponding to the CU split identifier split_cu_idx [x0][y0]. Derivation processing of the context index and the bypass flag will be described later in detail.

The CU split identifier decoding unit 113 supplies the context index ctxIdx and the bypass flag BypassFlag to the arithmetic code decoding unit 115, and instructs the arithmetic code decoding unit 115 to decode each bit included in coded data.

The CU split identifier decoding unit 113 interprets a Bin sequence configured by one or more Bins which are supplied by the bit decoding unit 117 and decodes a syntax value of the CU split identifier split_cu_idx [x0][y0] of a target CU. The CU split identifier decoding unit 113 outputs the decoded syntax value to the outside of the apparatus 1.

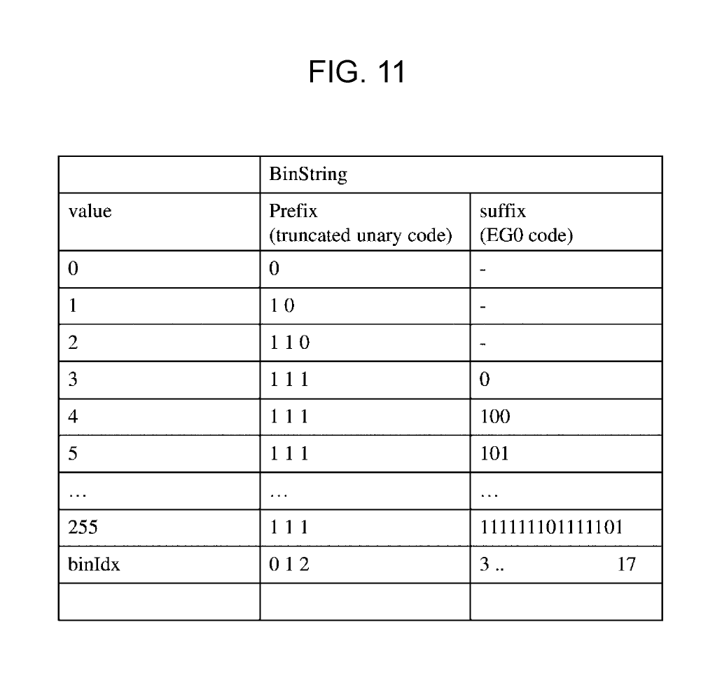

More specifically, the CU split identifier decoding unit 113 decodes (derives, transforms) the syntax value from the Bin sequence, for example, based on a correspondence table between values illustrated in FIG. 11 and Bin sequences (Bin sequence syntax value transform means). For example, if the Bin sequence is “0” (prefix=“0” and suffix=“−”), the CU split identifier decoding unit 113 decodes 0 as the syntax value based on FIG. 11. If the Bin sequence is “1110” (prefix=“111” and suffix=“0”), the CU split identifier decoding unit 113 decodes 4 as the syntax value. In a Bin sequence for a syntax value of the CU split identifier split_cu_idx [x0][y0], a prefix part (prefix in FIG. 11) uses the minimum value of the syntax value and 3, as a prefix value prefixVal. The prefix part is obtained by binarizing the prefix value through truncated rice binarization (TR binarization, Truncated unary binarization) which satisfies variable cRiceParam=0 and variable cMax=3. In a case where the syntax value is greater than 2, a suffix part (suffix in FIG. 11) uses a value of “syntax value −3” as a suffix value suffixVal. The suffix part is obtained by binarizing through 0-th order Exp-Golomb coding. Transform (inverse binarization) from the Bin sequence of the CU split identifier split_cu_idx [x][y] to a syntax value is not limited thereto and may be changed in a practicable range. For example, a fixed-length code for transforming the value itself of a Bin sequence to a syntax value may be provided. More specifically, if the Bin sequence of the CU split identifier split_cu_idx is “0”, “0” may be interpreted as the syntax value. If the Bin sequence of the CU split identifier split_cu_idx is “1”, “1” may be interpreted as the syntax value. Reversely, if the Bin sequence is “0”, “1” may be interpreted as the syntax value, and if the Bin sequence is “1”, “0” may be interpreted as the syntax value. Alternatively, the syntax value may be obtained from a Bin sequence based on a correspondence table between the Bin sequence and the k-th order Exp-Golomb code, without dividing the Bin sequence into the prefix part prefix and the suffix part suffix.

(Derivation Processing of Context Index and Bypass Flag)

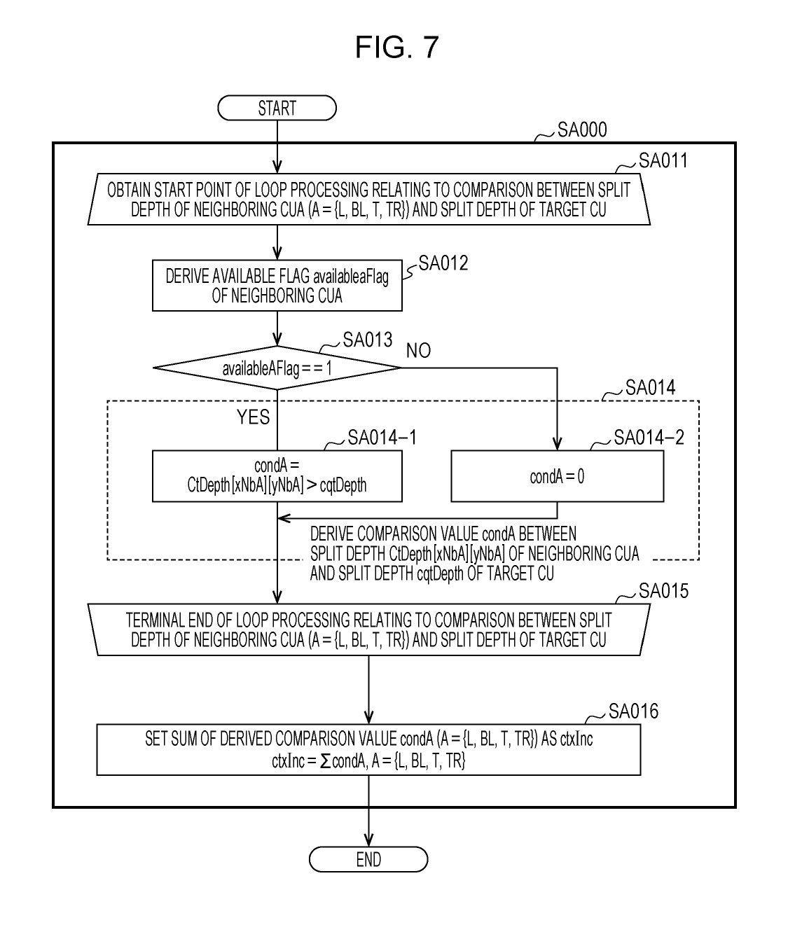

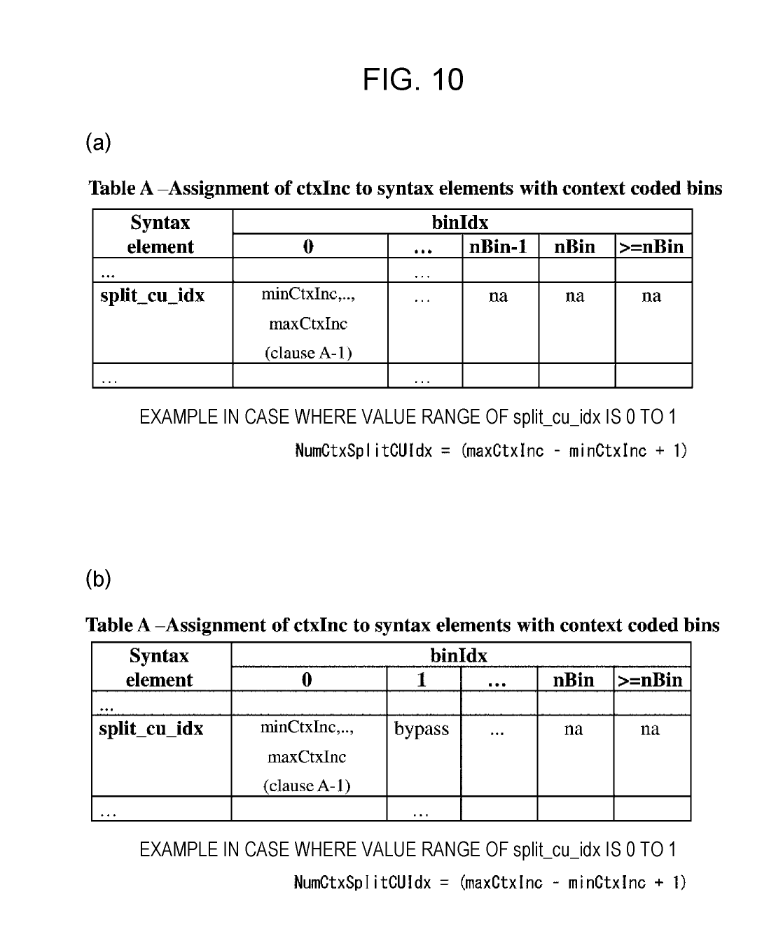

The derivation processing of the context index relating to the CU split identifier split_cu_idx [x0][y0] will be more specifically described below with reference to FIG. 7. The derivation processing of the context index of the CU split identifier split_cu_idx [x0][y0] is common on the decoding device side and the coding device side. In FIG. 10(a), binIdx indicates a bit position from the leading of a binary sequence (sequence configured by elements of 0 or 1) of a syntax element decoded by the CU split identifier decoding unit 113. binIdx=0 indicates the leading bit (first bit), binIdx=1 indicates a bit (second bit) next to the leading bit, . . . , and binIdx=M indicates the M-th bit. The number in FIG. 7 indicates a context increment ctxInc used in the context index. na in the table indicates that a bit at this position is not generated by decoding the syntax element. bypass indicates that decoding or coding is performed by not using a context but using bypass.

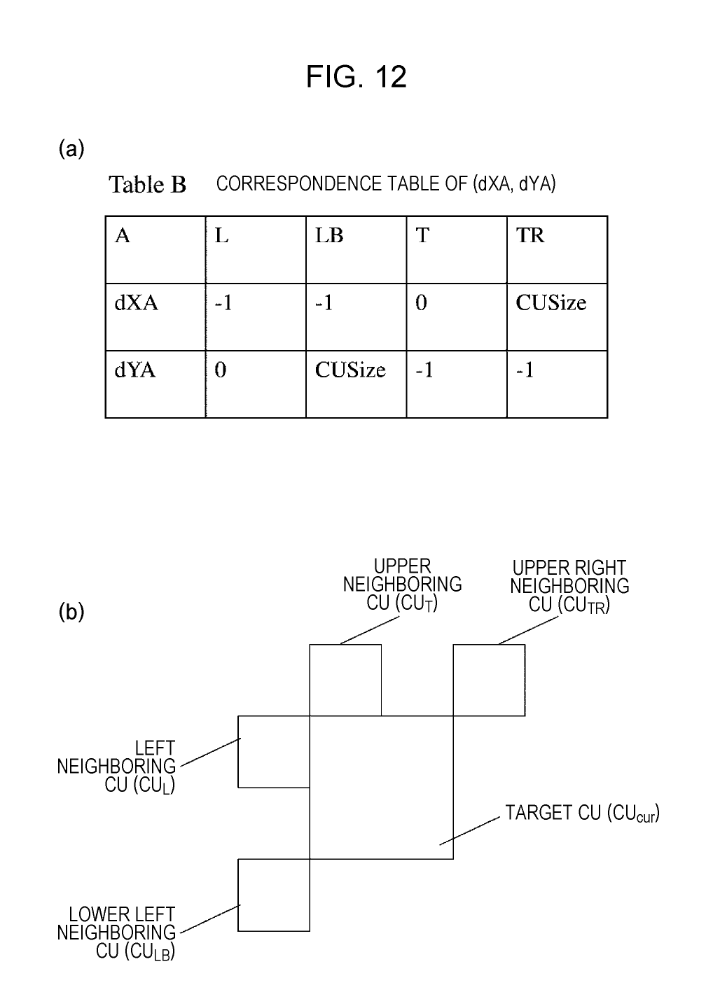

As illustrated in FIG. 10(a), the CU split identifier decoding unit 113 sets Bins (also referred to as Bins of a prefix part) corresponding to binIdx=0 to N (for example, N=0) in a Bin sequence of the CU split identifier split_cu_idx [x0][y0], as Bins which are decoded or coded with reference to the context. The CU split identifier decoding unit 113 derives a context increment value ctxInc for each of the Bins, for example, based on the split depth cqtDepth (or ctDepth) of a target CU and the split depth CtDepth [xNbA][yNbA] (A={L, BL, T, TR}) of a decoded neighboring CUA (A={L, BL, T, TR}). Here, a positional relationship between the target CU and the neighboring CUA (A={L, BL, T, TR}) will be described with reference to FIG. 12(b). In FIG. 12(b), a CU which is adjacent to the target CU on the left of the target CU (CUcur) is referred to as the left neighboring CUL (CUL). In a similar manner, a CU which is adjacent to the target CU on the lower left of the target CU (CUcur) is referred to as the lower left neighboring CULB (CULB). A CU which is adjacent to the target CU over the target CU (CUcur) is referred to as the upper neighboring CUT (CUT). A CU which is adjacent to the target CU on the upper right of the target CU (CUcur) is referred to as the upper right neighboring CUTR (CUTR).

Context index derivation processing regarding a Bin (binIdx=0, . . . , N) which refers to the context in the Bin sequence of the CU split identifier split_cu_idx [x0][y0] will be described below in detail with reference to FIGS. 7 to 12.

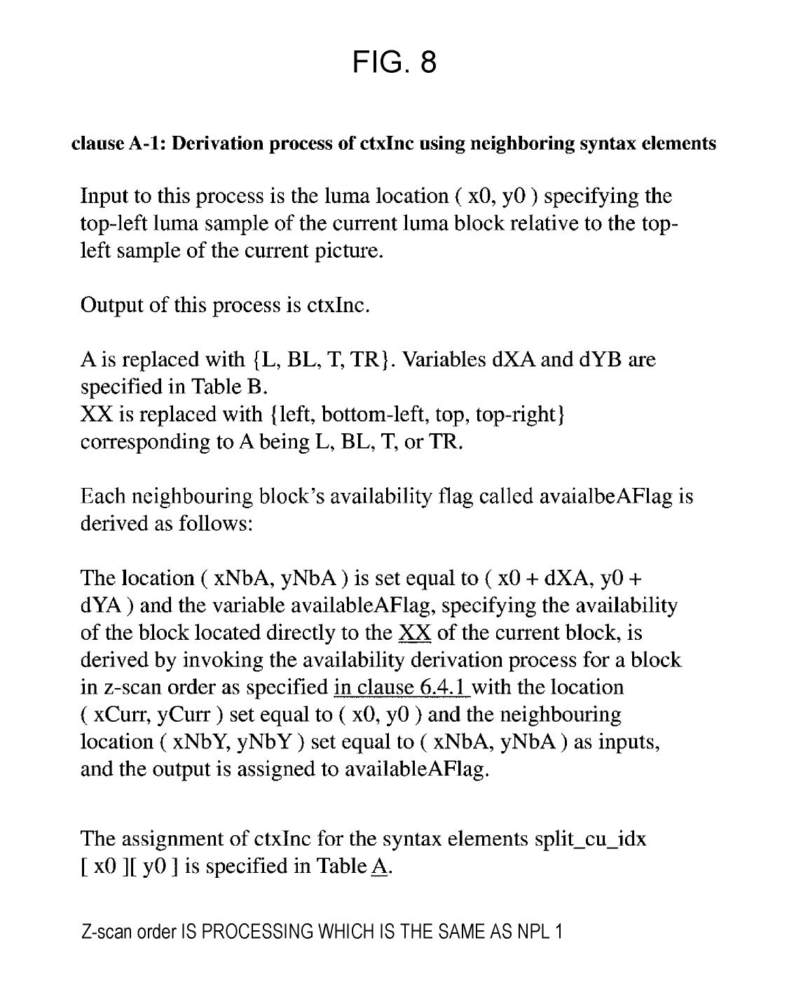

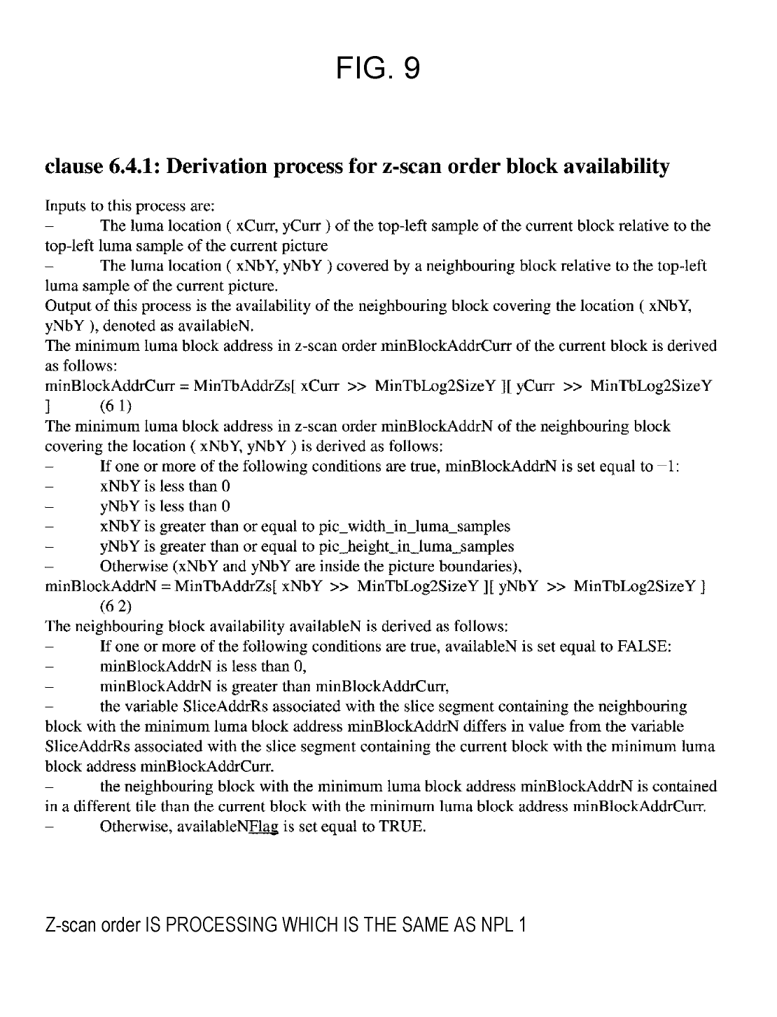

FIG. 7 is a flowchart illustrating the context index derivation processing regarding a CU split identifier, according to the embodiment of the present invention. FIG. 8 illustrates an example of a pseudo-code indicating the context index derivation processing regarding a CU split identifier, according to the embodiment of the present invention. FIG. 9 illustrates an example of a pseudo-code for deriving an available flag of a block in a Z scan order which is referred in the pseudo-code in FIG. 8.

(SA011) This process is a start point of loop processing regarding comparison between a split depth of the neighboring CUA (A={L, BL, T, TR}) and a split depth of a target CU. The CU split identifier decoding unit 113 performs the processes of Steps SA012 to S014 in an order of the left neighboring CUL, the lower left neighboring CULB, the upper neighboring CUT, and the upper right neighboring CUTR, and thus the CU split identifier decoding unit 113 derives a split-depth comparison value condA (A={L, BL, T, TR}) between the target CU and each of the neighboring CUs.

(SA012) The CU split identifier decoding unit 113 derives the available flag availableAFlag (A={L, BL, T, TR}) of the neighboring CUA (A={L, BL, T, TR}). The available flag availableAFlag of the neighboring CUA is a flag indicating whether or not the target CU can refer to a syntax value included in the neighboring CUA or a parameter derived from the syntax value. In a case where the value of the flag is 1 (true), the flag indicates being referenceable. In a case where the value of the flag is 0 (false), the flag indicates that the target CU is not capable of referring to the syntax value or the parameter. It may be interpreted that the available flag of the neighboring CUA indicates whether or not the neighboring CUA is provided. The meaning of the value of the available flag is not limited thereto. In a case where the value of the flag is 1 (true), the flag may be defined to indicate that the target CU is not capable of referring to the syntax value or the parameter, and, in a case where the value of the flag is 0 (false), the flag may be defined to indicate being referenceable.

(SA013) The CU split identifier decoding unit 113 determines whether or not the available flag availableAFlag (A ={L, BL, T, TR}) of the neighboring CUA (A={L, BL, T, TR}) is 1 (true). That is, the CU split identifier decoding unit 113 determines whether or not the target CU can refer to the syntax value or the parameter. In a case where the available flag availableAFlag of the neighboring CUA indicates being referenceable (Yes in Step SA013), the process proceeds to Step SA014-1. In a case where the available flag availableAFlag of the neighboring CUA indicates that target CU is not capable of referring to the syntax value or the parameter (No in Step SA013), the process proceeds to Step SA014-2.

(SA014-1) The CU split identifier decoding unit 113 reads the split depth CtDepthA [xNbA][yNbA] (A={L, BL, T, TR}) of the neighboring CUA from the outside (CU information decoding unit or frame memory) of the CU split identifier decoding unit 113. The CU split identifier decoding unit 113 derives a size comparison value condA (A={L, BL, T, TR}) to the split depth cqtDepth of the target CU by the following equation (eq. A-1).

condA=CtDepthA[xNbA][yNbA]>cqtDepth (eq. A-1)

That is, in a case where the split depth CtDepthA [xNbA][yNbA] of the neighboring CUA is greater than the split depth cqtDepth of the target CU, the CU split identifier decoding unit 113 sets 1 in condA. In other cases (case where the split depth CtDepthA [xNbA][yNbA] of the neighboring CUA is equal to or smaller than the split depth cqtDepth of the target CU), the CU split identifier decoding unit 113 sets 0 in condA. Here, coordinates (xNbA, yNbA) (A={L, BL, T, TR}) of the neighboring CUA is derived by the following equations (eq. A-2) and (eq. A-3), based on upper left coordinates (x0, y0) of the target CU and an offset (dxA, dYA) (A={L, BL, T, TR}) obtained by using the upper left coordinates (x0, y0) of the target CU as the start point.

xNbA=x0+dXA (eq. A-2)

yNbA=y0+dYA (eq. A-3)

Here, the offset (dXA,dYA) corresponding to each neighboring CUA (A={L, BL, T, TR}) is as shown in the table TableB illustrated in FIG. 12(a). That is, coordinates (xNbA, yNbA) of each neighboring CUA is derived as follows.

coordinates (xNbL, yNbL) of the left neighboring CUL=(x0−1, y0),

coordinates (xNbLB, yNbLB) of the lower left neighboring CULB=(x0−1, y0-CUSize),

coordinates (xNbT, yNbT) of the upper neighboring CUT=(x0, y0−1),

coordinates (xNbTR, yNbTR) of the upper right neighboring CUTR=(x0+CUSize, y0−1)

Here, the variable CUSize indicates the transverse width of the target CU in a case of the X coordinate, and indicates the longitudinal width thereof in a case of the Y coordinate.

(SA014-2) The CU split identifier decoding unit 113 sets 0 in the size comparison value condA (A={L, BL, T, TR}) between the split depth CtDepthA [xNbA][yNbA] (A={L, BL, T, TR}) of the neighboring CUA and the split depth cqtDepth of the target CU. That is, condA=0.

(SA015) This is the terminal end of the loop processing relating to the comparison between the split depth of the neighboring CUA (A={L, BL, T, TR}) and the split depth of the target CU.

(SA016) As represented by the following equation (eq. A-4) (or equation (eq. A-4a)), the CU split identifier decoding unit 113 sets the total sum of derived comparison values condA (A={L, BL, T, TR}), in the context increment value ctxInc.

ctxInc=ΣcondA, A={L,BL,T,TR} (eq. A-4)

ctxInc=condL+condBL+condT+condTR (eq. A-4a)

The numerical range of the context increment value satisfies, for example, minCtxInc <=ctxInc <=maxCtxInc. Here, the variable minCtxInc indicates the minimum value of context increment values ctxInc. The variable maxCtxInc indicates the maximum value of the context increment value ctxInc. In the example, the values of minCtxInc and maxCtxInc satisfy minCtxInc=0, maxCtxInc=4, respectively. Thus, in the example, the number NumCtxSplitCUIdx of contexts of Bins (binIdx=0, . . . , N) which refer to the context in the Bin sequence of the CU split identifier split_ctx_idx [x0][y0] satisfies an expression of maxCtxInc−minCtxInc+1=4. A derivation model of the context increment value ctxInc has a small value if the split depth cqtDepth of the target CU is smaller than the split depth of the neighboring CU in many cases. Conversely, the derivation model of the context increment value ctxInc has a large value if the split depth cqtDepth of the target CU is greater than the split depth of the neighboring CU in many cases. This is a context model suitable for an occurrence frequency of a symbol corresponding to each Bin of the syntax value of the CU split identifier split_cut_idx [x0][y0], for each split depth cqtDepth of a target CU. This allows the Bin sequence of the CU split identifier split_cu_idx [x0][y0] to be more efficiently subjected to arithmetic decoding or arithmetic coding.

(SA099) (not illustrated) Then, the CU split identifier decoding unit 113 derives a value obtained by adding a predetermined offset ctxIdx0ffset to the derived context increment value ctxInc, as the context index ctxIdx (equation (eq. A-5)) referred when each Bin is decoded.

ctxIdx=ctxInc+ctxIdxOffset (eq. A-5)

Here, the predetermined offset ctxIdx0ffset may have a value which varies depending on the slice type (I slice, P slice, and B slice). The predetermined offset ctxIdxOffset may be changed for each color component (each of a first color component, a second color component, and a third color component). The predetermined offset ctxIdxOffset may be set to be the common offset value without depending on the slice type or the color component.

Regarding Bins of binIdx=0, . . . , N, which refer to the context, the bypass flag BypassFlag is set to 0. For example, in the example in FIG. 10(a), the bypass flag BypassFlag is set to 0 for a Bin of binIdx=0, and a case where binIdx >value of 1 or greater does not occur. Thus, the bypass flag BypassFlag may be set to 0 and setting can be omitted. In the example in FIG. 10(b), the bypass flag BypassFlag is set to 0 for a Bin of binIdx=0, and a Bin (also referred to as a Bin of the suffix part) of binIdx=1 is a Bin which is decoded or coded without referred to the context (decoded or coded in the bypass mode) (in FIG. 10(b), the entry value is “bypass”). Thus, the bypass flag BypassFlag is set to 1 for each Bin. The context index ctxIdx for each Bin which does not refer to the context is set to 0.

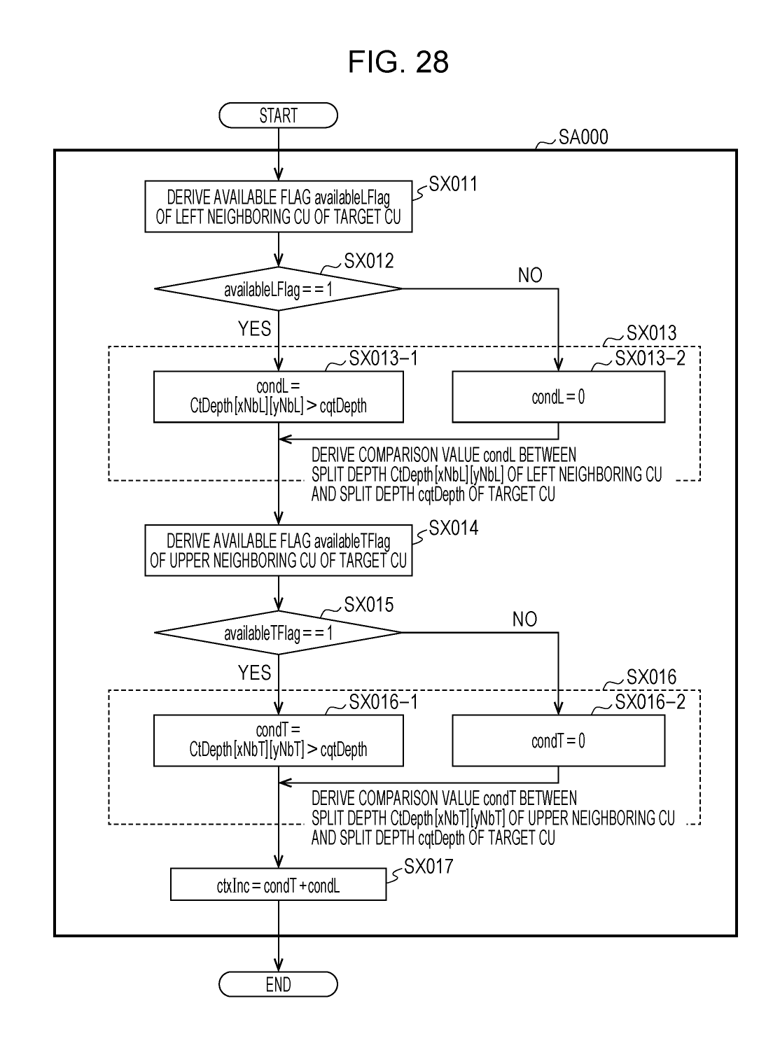

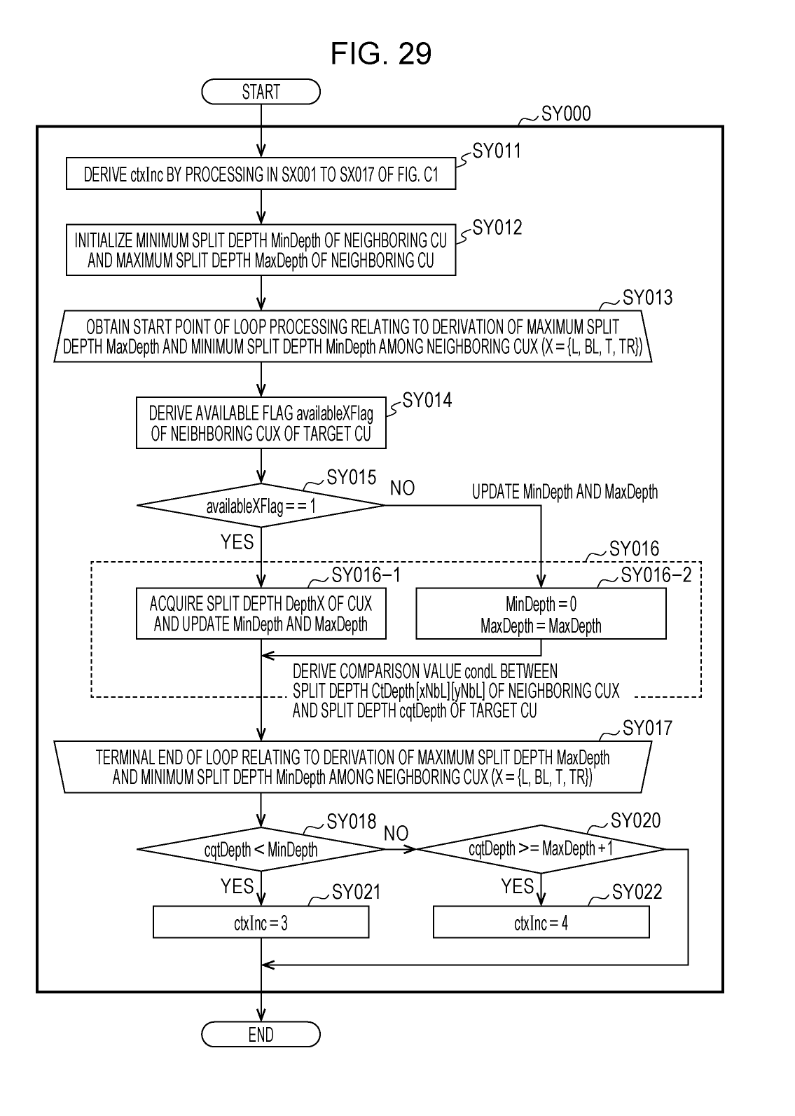

When the CTU size is extended, the CU split identifier decoding unit 113 refers to two or more neighboring CUs which are adjacent to the target CU, and thus can derive the context index ctxIdx based on a context model which is suitable for the occurrence probability of a symbol of a Bin (binIdx=0, . . . , N) which refers to the context in the Bin sequence corresponding to the CU split identifier split_cu_idx [x0][y0] of the target CU. In comparison to NPL 2 (FIGS. 28 and 29), the number of contexts relating to the CU split identifier split_cu_idx [x0][y0] (in NPL 2, split cu flag) is maintained to be equal, the coding efficiency is maintained, and the derivation processing of the context index is simplified (commonization of processing in FIG. 28 and processing in FIG. 29, and reduction of branch processing). Accordingly, an effect of reducing the processing amount of the decoding processing (processing amount of the coding processing) is exhibited.

(Appendix 1)

In the example, when the context increment value ctxInc relating to the context index ctxIdx for a Bin (binIdx=0, . . . , N) which refers to the context in the Bin sequence of the CU split identifier split_cu_idx [x0][y0] is derived, four neighboring CUs which are adjacent to the target CU, that is, the left neighboring CU, the lower left neighboring CU, the upper neighboring CU, and the upper right neighboring CU illustrated in FIG. 12(b) are referred to. However, it is not limited thereto. For example, N (N is 1 to 3) pieces of neighboring CUA may be selected from the left neighboring CU, the lower left neighboring CU, the upper neighboring CU, and the upper right neighboring CU, and the split depths CqtDepthA of the selected pieces of neighboring CUA may be referred to. Notification of the neighboring CU to be referred to may be performed in a parameter set (SPS, PPS, SH).

(Modification Example 1 of Derivation Processing of Context Index and Bypass Flag)

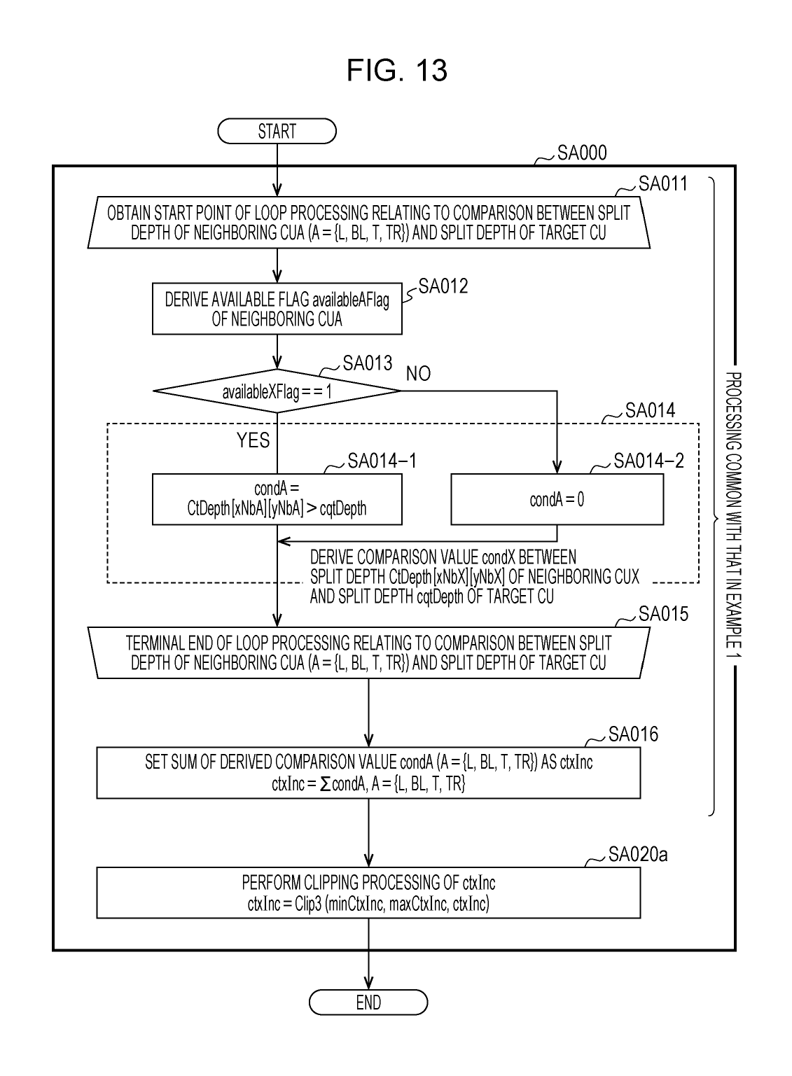

A modification example of the derivation processing of the context index relating to the CU split identifier split_cu_idx [x0][y0] will be described below with reference to FIG. 13. Descriptions of processes (SA011 to SA016 and SA099) which are common with that in the flowchart illustrated in FIG. 7 as described above will not be repeated and the process of Step SA020a which is the additional process will be described.

(SA020a) In order to decrease the number of contexts relating to the CU split identifier split_cu_idx [x0][y0], the CU split identifier decoding unit 113 limits the numerical range of the context increment value ctxInc derived in Step SA016, to a range of minCtxInc(second threshold) to maxCtxInc(first threshold) by the following equation (eq. A-6).

ctxInc=Clip3(minCtxInc, maxCtxInc, ctxInc) (eq. A-6)

Here, Clip3(X, Y, Z) is a clip operator that returns X in a case where Z is smaller than X, returns Y if Z is greater than Y, and returns Z in other cases (X<=Z<=Y).

For example, in a case where minCtxInc=0 and maxCtxInc=2 are set, the numerical range of the context increment value ctxInc is limited to be 0 to 2 by the process of Step SA020a. Thus, the number NumCtxSplitCUIdx of contexts is decreased to be 3.

In order to align the start point of the context increment value ctxInc to be 0, the context increment value ctxInc may be derived by an equation (eq. A-6a).

ctxInc=Clip3(minCtxInc, maxCtxInc, ctxInc)−minCtxInc (eq. A-6a)

In a case where only the upper limit value of the context increment value ctxInc is limited, the context increment value ctxInc may be derived by an equation (eq. A-6b).

ctxInc=ctxInc>maxCtxInc?maxCtxInc:ctxInc (eq. A-6b)

The equation (eq. A-6b) is an expression by a ternary operator, but may be also expressed by the following if statement (equation (eq. A-6c)).

if (ctxInc>maxCtxInc)ctxInc=maxCtxInc (eq. A-6c)

Accordingly, Modification Example 1 of the CU split identifier decoding unit 113 exhibits an effect similar to that in Example 1. Further, in comparison to Example 1, the numerical range of the context increment value ctxInc is limited and thus the number of contexts required for each Bin referring to the context is reduced while the coding efficiency is maintained. Thus, an effect of reducing a memory size required for holding the context is exhibited.

(Modification Example 2 of Derivation Processing of Context Index and Bypass Flag)

A modification example of the derivation processing of the context index relating to the CU split identifier split_cu_idx [x0][y0] will be described below. Descriptions of processes (SA011 to SA016 and SA099) which are common with that in the flowchart illustrated in FIG. 7 as described above will not be repeated. Step of the additional process is denoted by a dash sign (for example, SA0XX′), and only the additional process will be described. The process of Step SA020b which is the new additional process will be also described.

(SA011′) In addition to the process of SA011, the minimum split depth minCtDepth and the maximum split depth maxCtDepth in pieces of neighboring CUA (A={L, BL, T, TR}) are derived. Before the loop processing is started, the minimum split depth minCtDepth is initialized to be MaxCtDepthPS, and the maximum split depth maxCtDepth is initialized to be MinCtDepthPS. Here, the variables MinCtDepthPS and MaxCtDepthPS have values indicating the minimum split depth and the maximum split depth of a coding tree. The minimum split depth and the maximum split depth are obtained by the notification of the parameter set (SPS, PS, SH) or are derived by the parameter set (SPS, PS, SH).

(SA012′) Since this process is the same as SA012, descriptions thereof will not be repeated.

(SA013′) Since this process is the same as SA013, descriptions thereof will not be repeated.

(SA014-1′) In addition to the process of SA014-1, the minimum split depth minCtDepth and the maximum split depth maxCtDepth in the pieces of neighboring CUA are updated by the following equations (eq. A-7) and (eq. A-8), with reference to the split depth CtDepthA [xNbA][yNbA] of the neighboring CUA.

minCtDepth=minCtDepth>CtDepthA[xNbA][yNbA]?CtDepthA[xNbA][yNbA] (eq. A-7)

maxCtDepth=maxCtDepth<CtDepthA[xNbA][yNbA]?CtDepthA[xNbA][yNbA] (eq. A-8)

(SA014-2′) Since this process is the same as SA014-2, descriptions thereof will not be repeated.

(SA015′) This is the terminal end of the loop processing which relates to the comparison between the split depth of the neighboring CUA (A={L, BL, T, TR}) and the split depth of the target CU and to derivation of the minimum split depth minCtDepth and the maximum split depth maxCtDepth in neighboring CUs.

(SA016′) As represented by the above-described equation (eq. A-4) (or equation (eq. A-4a)), the CU split identifier decoding unit 113 sets the total sum of derived comparison values condA (A={L, BL, T, TR}), in the context increment value ctxInc, in a manner similar to that in SA016.

(SA020b) In order to decrease the number of contexts relating to the CU split identifier split_cu_idx [x0][y0], the CU split identifier decoding unit 113 updates the context increment value ctxInc derived in Step SA016′ to the context increment value corresponding to each of the minimum split depth minCtDepth(first split depth) and the maximum split depth maxCtDepth(second split depth) in the neighboring CUs, by the following equations (eq. A-9) and (eq. A-10).

ctxInc=cqtDepth<minCqtDepth?minCtxInc:ctxInc (eq. A-9)

ctxInc=cqtDepth>maxCqtDepth?maxCtxInc:ctxInc (eq. A-10)

That is, in a case where the split depth cqtDepth of the target CU is smaller than the minimum split depth in the neighboring CUs, the CU split identifier decoding unit 113 updates the context increment value ctxInc to the lower limit value (minimum value) minCtxInc (first context index value or first context increment value) of the context increment value. In a case where the split depth cqtDepth of the target CU is greater than the maximum split depth in the neighboring CUs, the CU split identifier decoding unit 113 updates the context increment value ctxInc to the upper limit value (maximum value) maxCtxInc (second context index value or second context increment value) of the context increment value.

Although described above, the derivation model of the context increment value ctxInc in Steps SA016 (and Step SA016′) has a small value if the split depth cqtDepth of the target CU is smaller than the split depth of the neighboring CU in many cases. Conversely, the derivation model of the context increment value ctxInc has a large value if the split depth cqtDepth of the target CU is greater than the split depth of the neighboring CU in many cases. Generally, in a case where the maximum value of a coding unit is increased, appearance probability of a coding unit (CU) provided at each hierarchical depth (split depth) has a tendency to be decreased. Thus, in a case where the split depth cqtDepth of the target CU is smaller than the minimum value (minimum split depth minCqtDepth) of the split depths in the neighboring CUs of the target CU, it is reasonable that the lower limit value minCtxInc of the context increment value is set as the context increment value ctxInc for a Bin which refers to the context in the bin sequence of the CU split identifier split_cu_idx [x0][y0]. In addition, it is possible to reduce the number of contexts while the coding efficiency is maintained.

In the similar manner, in a case where the split depth cqtDepth of the target CU is greater than the maximum value (maximum split depth maxCqtDepth) of the split depths in the neighboring CUs of the target CU, it is reasonable that the upper limit value maxCtxInc of the context increment value is set as the context increment value ctxInc for a Bin which refers to the context in the bin sequence of the CU split identifier split_cu_idx [x0][y0]. In addition, it is possible to reduce the number of contexts while the coding efficiency is maintained.

For example, if minCtxInc is set to 0 and maxCtxInc is set to 2, it is possible to reduce the number of contexts for a Bin which refers to the context in the bin sequence of the CU split identifier split_cu_idx [x0][y0], while the coding efficiency is maintained, in comparison to Example 1. Thus, an effect of reducing a memory size required for holding the context is exhibited.

(SA099′) Since this process is the same as SA099, descriptions thereof will not be repeated.

Accordingly, Modification Example 2 of the CU split identifier decoding unit 113 exhibits an effect similar to that in Example 1. Further, in comparison to Example 1, similar to the first modification, the number of contexts required for each Bin referring to the context is reduced while the coding efficiency is maintained. Thus, the effect of reducing a memory size required for holding the context is exhibited.

(Appendix 2)

In Modification Example 2 of the CU split identifier decoding unit 113, the minimum split depth minCqtDepth and the maximum split depth maxCqtDepth are derived from neighboring CUs of the target CU. However, it is not limited thereto. For example, a fixed value of a third split depth may be set to be the minimum split depth minCqtDepth, and a value of a fourth split depth which is different from the value of the third split depth may be set to be the maximum split depth maxCqtDepth, without searching for the neighboring CUs. The values of the third split depth and the fourth split depth may be obtained by the notification in the parameter set (SPS, PPS, SH) or may be predetermined between an image decoding apparatus and the corresponding image coding apparatus. Thus, with the simpler configuration, similar to Modification Example 2, it is possible to simplify the context index derivation processing on a Bin which refers to the context in the Bin sequence of the CU split identifier split_cu_idx [x0][y0], while the coding efficiency is maintained. In addition, an effect of reducing the processing amount of the decoding processing (processing amount of the coding processing) is exhibited.

[Video Coding Apparatus]

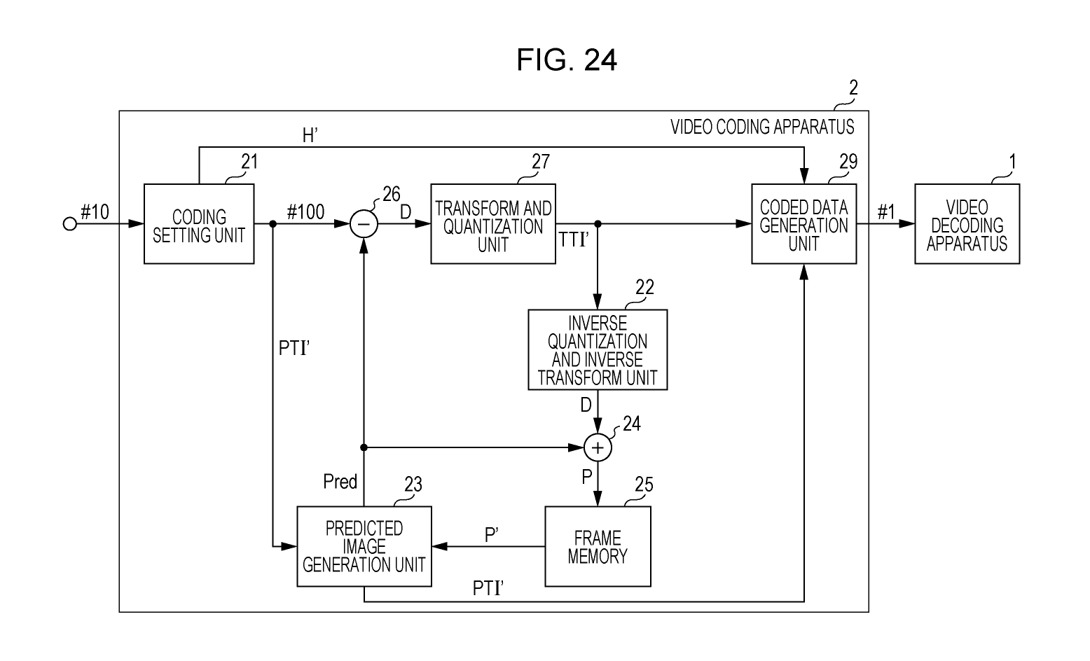

The video coding apparatus 2 according to the embodiment will be described below with reference to FIG. 24.

(Outline of Video Coding Apparatus)

Schematically, the video coding apparatus 2 is an apparatus that generates coded data #1 by coding an input image #10, and outputs the generated data.

(Configuration of Video Coding Apparatus)

Firstly, a configuration example of the video coding apparatus 2 will be described with reference to FIG. 24. FIG. 24 is a functional block diagram illustrating a configuration of the video coding apparatus 2. As illustrated in FIG. 24, the video coding apparatus 2 includes a coding setting unit 21, an inverse quantization and inverse transform unit 22, a predicted image generation unit 23, an adder 24, a frame memory 25, a subtractor 26, a transform and quantization unit 27, and a coded data generation unit (adaptive processing means) 29.

The coding setting unit 21 generates image data and various pieces of setting information which relate to coding, based on an input image #10.

Specifically, the coding setting unit 21 generates the next image data and the setting information.

Firstly, the coding setting unit 21 sequentially splits the input image #10 in a slice unit and in a tree block unit, and thus generates a CU image #100 for a target CU.

The coding setting unit 21 generates header information H′ based on the result of the splitting processing. The header information H′ includes (1) information regarding the size and the shape of a tree block belonging to a target slice and regarding the position of the tree block in the target slice and (2) CU information CU′ regarding the size and the shape of a CU belonging to each tree block and regarding the position of the CU in the target tree block.

Further, the coding setting unit 21 generates PT setting information PTI′ with reference to the CU image #100 and the CU information CU′. The PT setting information PTI′ includes (1) an available split pattern of a target CU for each PU and (2) information regarding all combinations of prediction modes which can be assigned to each PU.

The coding setting unit 21 supplies the CU image #100 to the subtractor 26. The coding setting unit 21 supplies the header information H′ to the coded data generation unit 29. The coding setting unit 21 supplies the PT setting information PTI′ to the predicted image generation unit 23.

The inverse quantization and inverse transform unit 22 performs inverse quantization and inverse orthogonal transform on quantized prediction residual for each block, so as to restore prediction residual for each block. The quantized prediction residual is supplied by the transform and quantization unit 27. The inverse orthogonal transform is described above in the description of the inverse quantization and inverse transform unit 13 illustrated in FIG. 2. Thus, here, the description thereof will not be repeated.

The inverse quantization and inverse transform unit 22 sums prediction residual for each block, in accordance with the split pattern designated by TT split information (which will be described later), and generates prediction residual D for the target CU. The inverse quantization and inverse transform unit 22 supplies the generated prediction residual D for the target CU to the adder 24.

The predicted image generation unit 23 generates a predicted image Pred for the target CU, with reference to a local decoded image P′ recorded in the frame memory 25 and PT setting information PTI′. The predicted image generation unit 23 sets a prediction parameter obtained by predicted image generation processing, in the PT setting information PTI′. The predicted image generation unit 23 transfers the PT setting information PTI′ after setting, to the coded data generation unit 29. The predicted image generation processing performed by the predicted image generation unit 23 is similar to the predicted image generation unit 14 in the video decoding apparatus 1. Thus, descriptions thereof will be not repeated.

The adder 24 generates a decoded image P for the target CU by adding the predicted image Pred (supplied by the predicted image generation unit 23) and the prediction residual D (supplied by the inverse quantization and inverse transform unit 22).

The decoded images P which have been decoded are sequentially recorded in the frame memory 25. Decoded images corresponding to all tree blocks (for example, all tree blocks which precedes a target tree block in an order of raster scan) which have been decoded ahead of the target tree block at a time point when the target tree block is decoded are recorded in the frame memory 25 along with parameters used for decoding the decoded images P.

The subtractor 26 generates prediction residual D for the target CU by subtracting the predicted image Pred from the CU image #100. The subtractor 26 supplies the generated prediction residual D to the transform and quantization unit 27.

The transform and quantization unit 27 performs orthogonal transform and quantization on the prediction residual D, so as to generate quantized prediction residual. Here, the orthogonal transform means orthogonal transform from a pixel domain to a frequency domain. Examples of the inverse orthogonal transform include discrete cosine transform and discrete sine transform.

Specifically, the transform and quantization unit 27 determines a split pattern of the target CU into one or a plurality of blocks, with reference to the CU image #100 and the CU information CU′. The transform and quantization unit 27 splits the prediction residual D into prediction residual for each block, in accordance with the determined split pattern.

The transform and quantization unit 27 generates prediction residual in the frequency domain by performing orthogonal transform on the prediction residual for each block. Then, the transform and quantization unit 27 generates quantized prediction residual for each block by quantizing the prediction residual in the frequency domain.

The transform and quantization unit 27 generates TT setting information TTI′ which includes the generated quantized prediction residual for each block, TT split information for designating the split pattern of the target CU, and information regarding all available split patterns of the target CU into blocks. The transform and quantization unit 27 supplies the generated TT setting information TTI′ to the inverse quantization and inverse transform unit 22 and the coded data generation unit 29.

The coded data generation unit 29 codes the header information H′, the setting information TTI′, and the PT setting information PTI′. The coded data generation unit 29 performs multiplexing of the header information H, the TT setting information TTI, and the PT setting information PTI which have been coded, so as to generate coded data #1. The coded data generation unit 29 outputs the generated coded data #1.

(Correspondence Relationship with Video Decoding Apparatus)

The video coding apparatus 2 includes components corresponding to the components of the video decoding apparatus 1. Here, the correspondence means having a relationship for performing similar processing or inverse processing.

For example, as described above, the predicted image generation processing of the predicted image generation unit 14 in the video decoding apparatus 1 is similar to the predicted image generation processing of the predicted image generation unit 23 in the video coding apparatus 2.

For example, processing of decoding a syntax value from a bit string in the video decoding apparatus 1 has a correspondence relationship with processing of coding a bit string from the syntax value in the video coding apparatus 2, as the inverse processing.

The correspondence relationship between the components in the video coding apparatus 2 and the components (CU information decoding unit 11, PU information decoding unit 12, and TU information decoding unit 13) of the video decoding apparatus 1 will be described below. Thus, an operation and the function of each of the components in the video coding apparatus 2 may be clarified more.

The coded data generation unit 29 corresponds to the decoding module 10. More specifically, the decoding module 10 derives a syntax value based on coded data and a syntax type, but the coded data generation unit 29 generates coded data based on a syntax value and a syntax type.

The coding setting unit 21 corresponds to the above-described CU information decoding unit 11 of the video decoding apparatus 1. The coding setting unit 21 is as follows, in comparison to the above-described CU information decoding unit 11.

The predicted image generation unit 23 corresponds to the above-described PU information decoding unit 12 and predicted image generation unit 14 in the video decoding apparatus 1. The predicted image generation unit 23 is as follows, in comparison to the PU information decoding unit 12 and the predicted image generation unit 14.

As described above, the PU information decoding unit 12 supplies coded data relating to motion information and a syntax type to the decoding module 10. The PU information decoding unit 12 derives a motion compensation parameter based on the motion information which has been decoded by the decoding module 10. The predicted image generation unit 14 generates a predicted image based on the derived motion compensation parameter.

On the contrary, the predicted image generation unit 23 determines a motion compensation parameter, and supplies a syntax value and a syntax type which relate to the determined motion compensation parameter, to the coded data generation unit 29 in the predicted image generation processing.

The transform and quantization unit 27 corresponds to the above-described TU information decoding unit 13 and inverse quantization and inverse transform unit 15 in the video decoding apparatus 1. The transform and quantization unit 27 is as follows, in comparison to the TU information decoding unit 13 and the inverse quantization and inverse transform unit 15.

The above-described TU split setting unit 131 in the TU information decoding unit 13 supplies coded data and a syntax type which relate to information indicating whether or not a node is split, to the decoding module 10. The TU split setting unit 131 performs TU splitting based on the information which indicates whether or not a node is split and has been decoded by the decoding module 10.

Further, a transform coefficient restoring unit 132 included in the above-described TU information decoding unit 13 supplies determination information, and coded data and a syntax type which relate to a transform coefficient, to the decoding module 10. The transform coefficient restoring unit 132 derives the transform coefficient based on the determination information and the transform coefficient which have been decoded by the decoding module 10.

On the contrary, the transform and quantization unit 27 determines a splitting method for TU splitting. The transform and quantization unit 27 supplies a syntax value and a syntax type which relate to information indicating whether or not a node is split, to the coded data generation unit 29.

The transform and quantization unit 27 supplies a syntax value and a syntax type which relate to a quantized transform coefficient obtained by performing transform and quantization on the prediction residual, to the coded data generation unit 29.

The video coding apparatus 2 according to the present invention is an image coding apparatus that splits a picture in a unit of a coding tree block and performs coding. The video coding apparatus 2 includes a coding tree split unit and an arithmetic coding unit (CU split identifier coding means, arithmetic coding device). The coding tree split unit recursively splits the coding tree block as a coding tree on the root. The arithmetic coding unit codes a CU split identifier split_cu_idx [x0][y0] which indicates whether or not the coding tree is split.

<Inverse Processing to Example 1>

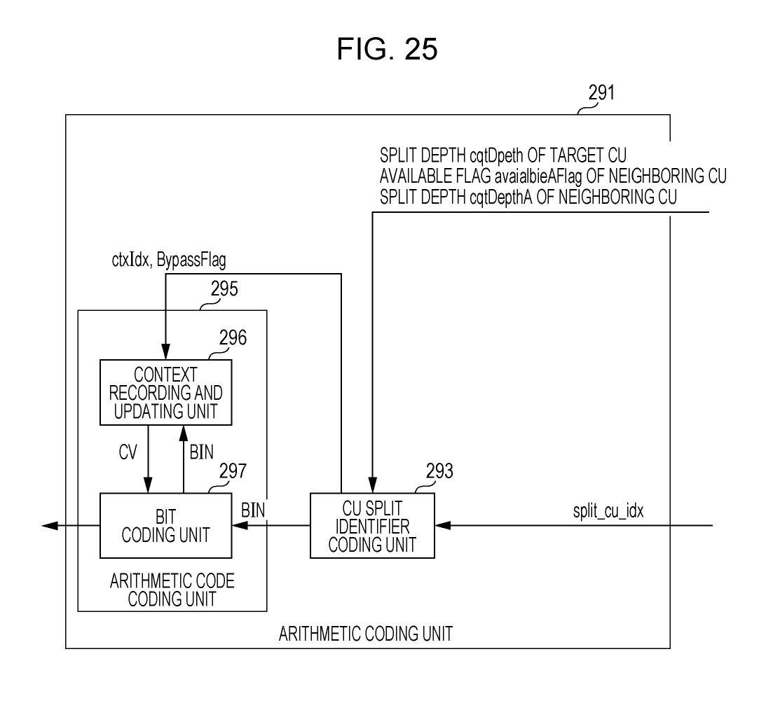

FIG. 25 is a block diagram illustrating a configuration of an arithmetic coding unit 291 that codes the CU split identifier split_cu_idx [x0][y0]. As illustrated in FIG. 25, the arithmetic coding unit 291 includes an arithmetic code coding unit 295 and a CU split identifier coding unit 293.

(Arithmetic Code Coding Unit 295)

The arithmetic code coding unit 295 has a configuration of coding each Bin supplied from the CU split identifier coding unit by referring to a context, and outputting each coded bit. As illustrated in FIG. 25, the arithmetic code coding unit 295 includes a context recording and updating unit 296 and a bit coding unit 297.

(Context Recording and Updating Unit 296)

The context recording and updating unit 296 has a function corresponding to the context recording and updating unit 116 in the arithmetic code decoding unit 115. The context recording and updating unit 296 has a configuration for recording and updating a context variable CV which is managed by each context index ctxIdx associated with each piece of syntax. Here, the context variable CV includes (1) a superior symbol MPS (most probable symbol) of which an occurrence probability is high, and (2) a probability state index pStateIdx for designating an occurrence probability of the superior symbol MPS.

In a case where the supplied bypass flag BypassFlag indicates 0, that is, in a case where coding is performed with reference to context, the context recording and updating unit 296 updates the context variable CV by referring the context index ctxIdx supplied by the CU split identifier coding unit 293 and the value of a Bin coded by the bit coding unit 297, and the context recording and updating unit 296 records the updated context variable CV until updated next. In addition, the superior symbol MPS is 0 or 1. Further, the superior symbol MPS and the probability state index pStateIdx are updated whenever the bit coding unit 297 codes one Bin.

In a case where the supplied bypass flag BypassFlag indicates 1, that is, in a case where coding is performed by using a context variable CV in which occurrence probability of symbols 0 and 1 is fixed to be 0.5 (also referred to as a bypass mode), the context recording and updating unit 296 causes the occurrence probability of symbols 0 and 1 to be normally fixed to be 0.5 regarding the value of the context variable CV. In addition, the context recording and updating unit 296 omits update of the context variable CV.

The context index ctxIdx may directly designate a context regarding each Bin of each piece of syntax. The context index ctxIdx may be an increment value from an offset which indicates a start value of a context index which is set for each piece of syntax.

(Bit Coding Unit 297)

The bit coding unit 297 corresponds to inverse processing to the bit decoding unit 117 in the arithmetic code decoding unit 115. The bit coding unit 297 codes each Bin supplied from the CU split identifier coding unit 293, with reference to the context variable CV recorded in the context recording and updating unit 296. The value of the coded Bin is also supplied to the context recording and updating unit 296 so as to be referred to for updating the context variable CV.

(CU Split Identifier Coding 293)

The CU split identifier coding unit 293 corresponds to inverse processing to the CU split identifier decoding unit 113 in the arithmetic decoding unit 191.

The CU split identifier coding unit 293 codes (derives, transforms) a syntax value of the CU split identifier split_cu_idx [x0][y0] of the target CU, which is supplied from the outside, and codes (derives, transforms) a Bin sequence corresponding to the syntax value, for example, based on a correspondence table between the value illustrated in FIG. 11 and the Bin sequence. For example, if the syntax value is 0, the CU split identifier coding unit 293 derives “0” (prefix=“0”, suffix=“−”) as the Bin sequence. If the syntax value is 4, the CU split identifier coding unit 293 derives “1110” (prefix=“111”, suffix=“0”) as the Bin sequence. Transform (binarization) of the syntax value of the CU split identifier split_cu_idx [x][y] to the Bin sequence is not limited thereto and may be changed in a practicable range. For example, a fixed-length code for transforming the syntax value itself to a syntax value may be provided. More specifically, if the syntax value of the CU split identifier split_cu_idx is “0”, “0” may be interpreted as the Bin sequence. If the syntax value of the CU split identifier split_cu_idx is “1”, “1” may be interpreted as the Bin sequence. Reversely, if the syntax value is “0”, “1” may be interpreted as the Bin sequence, and if the syntax value is “1”, “0” may be interpreted as the Bin sequence. Alternatively, the Bin sequence may be obtained from the syntax value based on a correspondence table between a value and the k-th order Exp-Golomb code, without transforming the syntax value to a Bin sequence configured by a prefix part prefixt and a suffix part suffix.

The CU split identifier coding unit 293 derives the context index ctxIdx for determining a context which is used when the arithmetic code coding unit 295 codes the Bin sequence of the CU split identifier split_cu_idx [x0][y0], and the bypass flag BypassFlag indicating whether or not the bypass mode is applied. The derivation is performed by processing which is the same as the derivation processing (including Example 1, Modification Example 1, Modification Example 2, and appendixes thereof) of the context index and the bypass flag, which has been described in the CU split identifier decoding unit 113. It is assumed that interpretation is performed in a state where the CU split decoding unit 113 is replaced with the CU split identifier coding unit 293.

The CU split identifier coding unit 293 supplies the context index ctxIdx and the bypass flag BypassFlag which have been derived, and the Bin sequence to the arithmetic code coding unit 295, and instructs the arithmetic code coding unit 295 to code each Bin in the Bin sequence.

Hereinafter, the CU split identifier coding unit 293 according to the example has a configuration of instructing the arithmetic code coding unit 295 to switch a context and perform coding on a Bin which refers to a context in the Bin sequence of the CU split identifier split_cu_idx [x0][y0], based on the split depth cqtDepth of the target CU and the split depth CtDepthA [xNbA][yNbA] (A={L, BL, T, TR}) of the coded neighboring CUA (A={L,BL,T,TR}). As illustrated in FIG. 10(b), the CU split identifier coding unit 293 has a configuration of coding a Bin by the bypass mode if the Bin which does not refer to a context is provided.

When the CTU size is extended, the CU split identifier coding unit 293 refers to two or more neighboring CUs which are adjacent to the target CU, and thus can derive the context index ctxIdx based on a context model which is suitable for the occurrence probability of a symbol of a Bin (binIdx=0, . . . , N) which refers to the context in the Bin sequence corresponding to the CU split identifier split_cu_idx [x0][y0] of the target CU. In comparison to NPL 2 (FIGS. 28 and 29), the number of contexts relating to the CU split identifier split_cu_idx [x0][y0] (in NPL 2, split cu flag) is maintained to be equal, the coding efficiency is maintained, and the derivation processing of the context index is simplified (commonization of processing in FIG. 28 and processing in FIG. 29, and reduction of branch processing). Accordingly, an effect of reducing the processing amount of the coding processing is exhibited. In a case where the paragraph of (Modification Example 1 of Derivation Processing of Context Index and Bypass Flag) is applied, the CU split identifier coding unit 293 exhibits an effect which is similar to that in Example 1. Further, in comparison to Example 1, the numerical range of the context increment value ctxInc is limited and thus the number of contexts required for each Bin referring to the context is reduced while the coding efficiency is maintained. Thus, an effect of reducing a memory size required for holding the context is exhibited. In a case where the paragraph of (Modification Example 2 of Derivation Processing of Context Index and Bypass Flag) is applied, an effect which is similar to that in Example 1 is exhibited. Further, in comparison to Example 1, similar to the first modification, the number of contexts required for each Bin referring to the context is reduced while the coding efficiency is maintained. Thus, the effect of reducing a memory size required for holding the context is exhibited.

### Application Example

The above-described video coding apparatus 2 and video decoding apparatus 1 may be mounted and used in various items of equipment which perform transmission, reception, recording, and reproducing of videos. In addition, the videos may be natural images which are captured by a camera or the like, and may be artificial images (including CG and GUI) generated by a computer or the like.

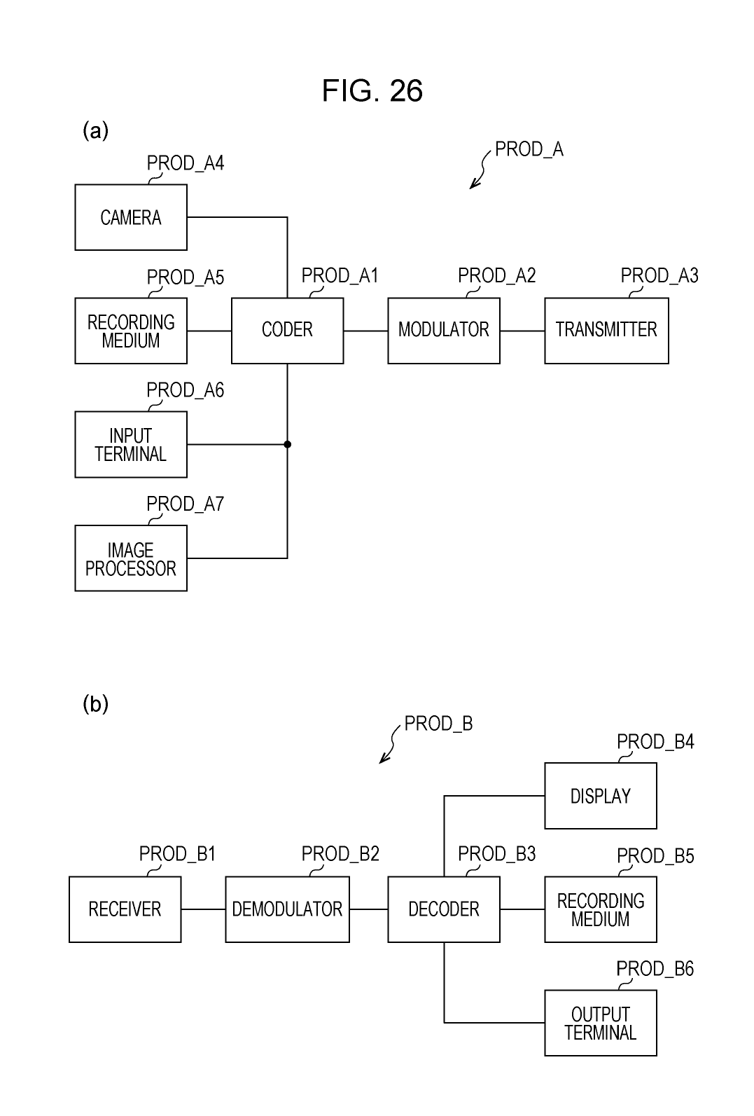

First, with reference to FIG. 26, a description will be made that the video coding apparatus 2 and the video decoding apparatus 1 which are described above can be used for transmission and reception of videos.

FIG. 26(a) is a block diagram illustrating a configuration of transmission equipment PROD_A including the video coding apparatus 2 mounted therein. As illustrated in FIG. 26(a), the transmission equipment PROD_A includes a coder PROD_A1which obtains by coding a video, a modulator PROD_A2 which obtains a modulated signal by modulating the coded data obtained by the coder PROD_A1, and a transmitter PROD_A3 which transmits the modulated signal obtained by the modulator PROD_A2. The above-described video coding apparatus 2 is used as the coder PROD_A1.

The transmission equipment PROD_A may further include a camera PROD_A4 which captures a video as a supply source of a video which is input to the coder PROD_A1, a recording medium PROD_A5 which records the video thereon, an input terminal PROD_A6 for inputting a video from an external device, and an image processor A7 which generates or processes an image. FIG. 26(a) illustrates a configuration in which the transmission equipment PROD_A includes all the components, but some of the components may be omitted.

In addition, the recording medium PROD_A5 may record a video which is not coded, and may record a video which is coded in a coding method for recording different from a coding method for transmission. In the latter case, a decoder (not illustrated) which decodes coded data read from the recording medium PROD_A5 according to a coding method for recording may be provided between the recording medium PROD_A5 and the coder PROD_A1.

FIG. 26(b) is a block diagram illustrating a configuration of reception equipment PROD _B including the video decoding apparatus 1 mounted therein. As illustrated in FIG. 26(b), the reception equipment PROD _B includes a receiver PROD_B1 which receives a modulated signal, a demodulator PROD_B2 which obtains coded data by demodulating the modulated signal received by the receiver PROD_B1 and a decoder PROD_B3 which obtains a video by decoding the coded data obtained by the demodulator PROD_B2. The above-described video decoding apparatus 1 is used as the decoder PROD_B3.

The reception equipment PROD_B may further include a display PROD_B4 which displays a video as a supply source of the video which is output by the decoder PROD_B3, a recording medium PROD_B5 which records a video, and an output terminal PROD_B6 which outputs a video to an external device. FIG. 26(b) illustrates a configuration in which the reception equipment PROD _B includes all the components, but some of the components may be omitted.

In addition, the recording medium PROD_B5 may record a video which is not coded, and may record a video which is coded in a coding method for recording different from a coding method for transmission. In the latter case, a coder (not illustrated) which codes a video acquired from the decoder PROD_B3 according to a coding method for recording may be provided between the decoder PROD_B3 and the recording medium PROD_B5.

In addition, a transmission medium for transmitting a modulated signal may be wireless and wired. Further, a transmission aspect of transmitting a modulated signal may be broadcast (here, indicating a transmission aspect in which a transmission destination is not specified in advance) and may be communication (here, indicating a transmission aspect in which a transmission destination is specified in advance). In other words, transmission of a modulated signal may be realized by any one of wireless broadcast, wired broadcast, wireless communication, and wired communication.

For example, a broadcasting station (a broadcasting facility or the like) and a reception station (a television receiver or the like) in terrestrial digital broadcasting are respectively examples of the transmission equipment PROD_A and the reception equipment PROD _B which transmit and receive a modulated signal in wireless broadcast. In addition, a broadcasting station (a broadcasting facility or the like) and a reception station (a television receiver or the like) in cable television broadcasting are respectively examples of the transmission equipment PROD_A and the reception equipment PROD _B which transmit and receive a modulated signal in wired broadcast.

In addition, a server (a workstation or the like) and a client (a television receiver, a personal computer, a smart phone, or the like) in a video on demand (VOD) service or a video sharing service using the Internet or the like are respectively examples of the transmission equipment PROD_A and the reception equipment PROD _B which transmit and receive a modulated signal in communication (typically, either a wireless or wired medium is used as a transmission medium in a LAN, and a wired medium is used as a transmission medium in a WAN). Here, the personal computer includes a desktop PC, a laptop PC, and a tablet PC. Further, the smart phone also includes a multifunction mobile phone terminal.

In addition, the client in the video sharing service has not only a function of decoding coded data which is downloaded from the server and displaying the data on a display but also a function of coding a video captured by a camera and uploading the video to the server. In other words, the client in the video sharing service functions as both of the transmission equipment PROD_A and the reception equipment PROD_B.

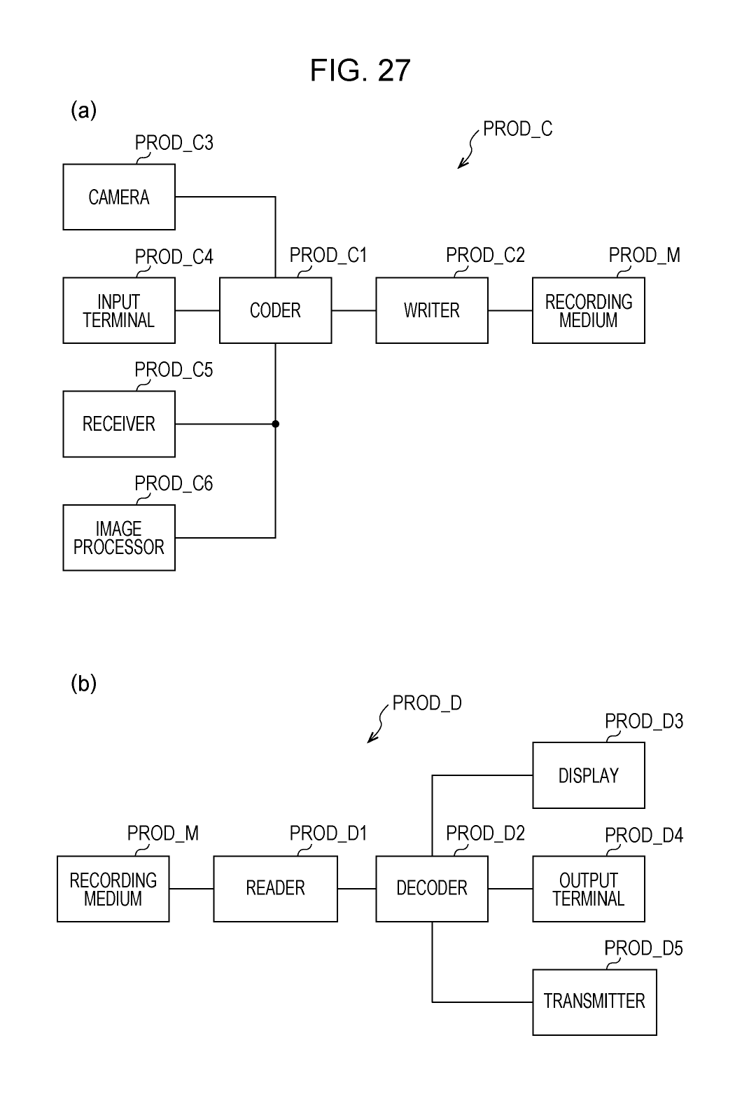

Next, with reference to FIG. 27, a description will be made that the video coding apparatus 2 and the video decoding apparatus 1 which are described above can be used for recording and reproducing videos.

FIG. 27(a) is a block diagram illustrating a configuration of recording equipment PROD_C including the video coding apparatus 2 mounted therein. As illustrated in FIG. 27(a), recording equipment PROD_C includes a coder PROD_C1 which obtains by coding a video, and writer PROD_C2 which writes the coded data obtained by the coder PROD_C1 on a recording medium PROD_M. The above-described video coding apparatus 2 is used as the coder PROD_C1.

In addition, the recording medium PROD_M may be (1) built into the recording equipment PROD_C, such as a hard disk drive (HDD), a solid state drive (SSD), (2) connected to the recording equipment PROD_C, such as a SD memory card or a universal serial bus (USB) flash memory, and (3) loaded in a drive device (not illustrated) built into the recording equipment PROD_C, such as a digital versatile disc (DVD) or a Blu-ray Disc (registered trademark, BD).

In addition, the recording equipment PROD_C may further include a camera PROD_C3 which captures a video as a supply source of a video which is input to the coder PROD_C1, an input terminal PROD_C4 for inputting a video from an external device, a receiver PROD_C5 which receives a video, and an image processor C6 which generates or processes an image. FIG. 27(a) illustrates a configuration in which the recording equipment PROD_C includes all the components, but some of the components may be omitted.

Further, the receiver PROD_C5 may receive a video which is not coded, and may receive a video which is coded in a coding method for recording different from a coding method for transmission. In the latter case, a decoder (not illustrated) for transmission which decodes coded data which is coded in a coding method for transmission may be provided between the receiver PROD_C5 and the coder PROD_C1.

The recording equipment PROD_C may include, for example, a DVD recorder, a BD recorder, and a hard disk drive (HDD) recorder (in this case, the input terminal PROD_C4 or the receiver PROD_C5 is a main supply source of a video). Further, examples of the recording equipment PROD_C are also a camcorder (in this case, the camera PROD_C3 is a main supply source of a video), a personal computer (in this case, the receiver PROD_C5 or the image processor C6 is a main supply source of a video), and a smart phone (in this case, the camera PROD_C3 or the receiver PROD_C5 is a main supply source of a video).

FIG. 27(b) is a block illustrating a configuration of reproducing equipment PROD_D including the video decoding apparatus 1 mounted therein. As illustrated in FIG. 27(b), the reproducing equipment PROD_D includes a reader PROD_D1 which reads coded data which is written on the recording medium PROD_M, and a decoder PROD_D2 which obtains a video by decoding the coded data read by the reader PROD_D1. The above-described video decoding apparatus 1 is used as the decoder PROD_D2.

In addition, the recording medium PROD_M may be (1) built into the reproducing equipment PROD_D, such as an HDD, an SSD, (2) connected to the reproducing equipment PROD_D, such as a SD memory card or a USB flash memory, and (3) loaded in a drive device (not illustrated) built into the reproducing equipment PROD_D, such as a DVD or a BD.

In addition, the reproducing equipment PROD_D may further include a display PROD_D3 which displays a video as a supply source of the video which is output by the decoder PROD_D2, an output terminal PROD_D4 which outputs a video to an external device, and a transmitter PROD_D5 which transmits a video. FIG. 27(b) illustrates a configuration in which the reproducing equipment PROD_D includes all the components, but some of the components may be omitted.

In addition, the transmitter PROD_D5 may transmit a video which is not coded, and may transmit a video which is coded in a coding method for transmission different from a coding method for recording. In the latter case, a coder (not illustrated) which codes a video in a coding method for transmission may be provided between the decoder PROD_D2 and the transmitter PROD_D5.

The reproducing equipment PROD_D may include, for example, a DVD player, a BD player, and an HDD player (in this case, the output terminal PROD_D4 connected to a television receiver is a main supply source of a video). Further, examples of the reproducing equipment PROD_D are also a television receiver (in this case, the display PROD_D3 is a main supply source of a video), a digital signage (also called an electronic signboard or an electronic bulletin board; in this case, the display PROD_D3 or the transmitter PROD_D5 is a main supply source of a video), a desktop PC (in this case, the output terminal PROD_D4 or the transmitter PROD_D5 is a main supply source of a video), a laptop or tablet PC (in this case, the display PROD_D3 or the transmitter PROD_D5 is a main supply source of a video), and a smart phone (in this case, the display PROD_D3 or the transmitter PROD_D5 is a main supply source of a video).

(Realization in Hardware and Realization in Software)

Each block of the video decoding apparatus 1 and video coding apparatus 2 which are described above may be realized in hardware by using logic circuits formed on an integrated circuit (IC chip), and may be realized in software by using a central processing unit (CPU).

In the latter case, each of the apparatuses includes a CPU which executes commands of a program, a read only memory (ROM) which stores the program, a random access memory (RAM) on which the program is developed, and a storage device (recording medium) such as a memory which stores the program and various items of data. In addition, the object of the present invention can also be achieved by supplying a recording medium which causes a computer to read program codes (an executable program, an intermediate code program, or a source program) of a control program of each of the apparatuses which are software for realizing the above-described functions, to each of the apparatuses, and by the computer (or a CPU or a MPU) reading and executing the program codes recorded on the recording medium.

As the recording medium, there may be the use of, for example, tapes such as a magnetic tape or a cassette tape, disks or discs including a magnetic disk such as a floppy (registered trademark) disk or a hard disk and an optical disc such as a compact disc read-only memory (CD-ROM), a magneto-optical disc (MO), a mini disc (MD), a digital versatile disc (DVD), a CD-recordable (CD-R), or a Blu-ray disc (registered trademark), cards such as an IC card (including a memory card) and an optical card, semiconductor memories such as a mask ROM, an erasable programmable read-only memory (EPROM), an electrically erasable and programmable read-only memory (EEPROM) (registered trademark) and a flash ROM, or logic circuits such as a programmable logic device (PLD) and field programmable gate array (FPGA).

In addition, each of the apparatuses may be configured to be connected to a communication network, and the program codes may be supplied thereto via the communication network. The communication network is not particularly limited as long as the program codes can be transmitted. For example, the Internet, an intranet, an extranet, a local area network (LAN), an integrated service digital network (ISDN), a value-added network (VAN), a community antenna television/cable television (CATV), a communication network, a virtual private network, a telephone line network, a mobile communication network, and a satellite communication network, may be used. In addition, a transmission medium forming the communication network is not particularly limited to a specific configuration or type as long as the program codes can be transmitted. The transmission medium may use a wired medium such as Institute Of Electrical and Electronic Engineers (IEEE) 1394, a USB, a power line carrier, a cable TV line, a telephone line, or an asymmetric digital subscriber line (ADSL), and a wireless medium such as infrared rays in Infrared Data Association (IrDA) or remote control, Bluetooth (registered trademark), IEEE802.11 wireless, High Data Rate (HDR), near field communication (NFC), Digital Living Network Alliance (DLNA (registered trademark)), a mobile station network, a satellite line, or a terrestrial digital network. In addition, the present invention may also be realized in a form of a computer data signal which is implemented by electronically transmitting the program codes and is embedded in a carrier.

The present invention is not limited to each of the above-described embodiments and may have various modifications in a range recited in the claims. That is, an embodiment obtained by combining the technical means which is appropriately changed in the range recited in the claims is also included in the technical scope of the present invention.

### INDUSTRIAL APPLICABILITY

The present invention can be suitably applied to an image decoding apparatus that decodes coded data obtained by coding image data, and an image coding apparatus that generates coded data obtained by coding image data. The present invention can be suitably applied to a data structure of coded data which is generated by the image coding apparatus and is referred by the image decoding apparatus.

### REFERENCE SIGNS LIST

1 VIDEO DECODING APPARATUS (IMAGE DECODING APPARATUS)

10 DECODING MODULE

11 CU INFORMATION DECODING UNIT

12 PU INFORMATION DECODING UNIT

13 TU INFORMATION DECODING UNIT

16 FRAME MEMORY

191 ARITHMETIC DECODING UNIT

113 CU SPLIT IDENTIFIER DECODING UNIT

115 ARITHMETIC CODE DECODING UNIT

116 CONTEXT RECORDING AND UPDATING UNIT

117 BIT DECODING UNIT

2 VIDEO CODING APPARATUS (IMAGE CODING APPARATUS)

131 TU SPLIT SETTING UNIT

21 CODING SETTING UNIT

25 FRAME MEMORY

29 CODED DATA GENERATION UNIT

291 ARITHMETIC CODING UNIT

293 CU SPLIT IDENTIFIER CODING UNIT

295 ARITHMETIC CODE CODING UNIT

296 CONTEXT RECORDING AND UPDATING UNIT

297 BIT CODING UNIT

1. An arithmetic decoding device comprising:
a context index deriving circuit for deriving a context index for designating a context;
an arithmetic code decoding circuit for decoding a Bin sequence configured by one or a plurality of Bins, from coded data with reference to a bypass flag and the context designated by the context index; and
a CU split identifier decoding circuit for decoding a syntax value of a CU split identifier relating to a target CU, from the Bin sequence,
wherein the context index deriving circuit derives the context index relating to the CU split identifier, based on a split depth of the target CU and split depths of three or more decoded neighboring CUs.

2. The arithmetic decoding device according to claim 1,
wherein the context index deriving circuit derives a value of a first threshold as the context index relating to the CU split identifier, in a case where the derived context index relating to the CU split identifier is greater than the first threshold.

3. An arithmetic decoding device comprising:
a context index deriving circuit for deriving a context index for designating a context;
an arithmetic code decoding circuit for decoding a Bin sequence configured by one or a plurality of Bins, from coded data with reference to a bypass flag and the context designated by the context index; and
a CU split identifier decoding circuit for decoding a syntax value of a CU split identifier relating to a target CU, from the Bin sequence,
wherein the context index deriving means
derives a first context index value as the context index relating to the CU split identifier, in a case where, regarding the derived context index relating to the CU split identifier, the split depth of the target CU is smaller than a first split depth, and
derives a second context index value which is different from the first context index value, as the context index relating to the CU split identifier, in a case where the split depth of the target CU is greater than a second split depth.

4. The arithmetic decoding device according to claim 3,
wherein the first split depth is the minimum split depth among split depths of one or more decoded neighboring CUs.

5. The arithmetic decoding device according to claim 3,
wherein the second split depth is the maximum split depth among split depths of one or more decoded neighboring CUs.

6. The arithmetic decoding device according to claim 3,
wherein the first context index value is 0.

7. The arithmetic decoding device according to claim 3,
wherein the second context index value is a value obtained by subtracting 1 from the number of contexts of the CU split identifier.

8-9. (canceled)

10. An arithmetic coding device comprising:
a CU split identifier coding circuit for coding a syntax value of a CU split identifier relating to a target CU, in a form of a Bin sequence;
a context index deriving circuit for deriving a context index for designating a context; and
an arithmetic code coding circuit for generating coded data with reference to a bypass flag and the context designated by the context index, by coding a Bin sequence configured by one or a plurality of Bins,
wherein the context index deriving circuit
derives a first context index value as the context index relating to the CU split identifier, in a case where the split depth of the target CU is smaller than a first split depth, and
derives a second context index value which is different from the first context index value, as the context index relating to the CU split identifier, in a case where the split depth of the target CU is greater than a second split depth.

11. The arithmetic coding device according to claim 10,
wherein the first split depth is the minimum split depth among split depths of one or more coded neighboring CUs.

12. The arithmetic coding device according to claim 10,
wherein the second split depth is the maximum split depth among split depths of one or more coded neighboring CUs.

13. The arithmetic coding device according to claim 10,
wherein the first context index value is 0.

14. The arithmetic coding device according to claim 10,
wherein the second context index is a value obtained by subtracting 1 from the number of contexts of the CU split identifier.
